(19) United States
(12) Patent Application Publication
(10) Pub. No.: US 2026/0253255 A1
(43) Pub. Date: Aug. 27, 2026

(54) SELECTIVE STORAGE OR TRANSMISSION OF VISION ENCODER OUTPUT

(71) Applicant: QUALCOMM Incorporated, San Diego, CA (US)

(72) Inventors: Munawar HAYAT, San Diego, CA (US); Titash RAKSHIT, Austin, TX (US)

(21) Appl. No.: 19/543,558

(22) Filed: Feb. 18, 2026

Related U.S. Application Data
(60) Provisional application No. 63/764,233, filed on Feb. 27, 2025.

(51) Int. Cl. G06T 9/00; G06T 1/60; G06V 10/74

(52) U.S. Cl. CPC G06T 9/00; G06T 1/60; G06V 10/761

(57) ABSTRACT

A device includes a memory configured to store sets of encoder output data. The device also includes one or more processors coupled to the memory and configured to add, to the memory, first encoder output data for image-based cognitive analysis, the first encoder output data representing a first image frame of a sequence of image frames. The one or more processors are configured to use a vision encoder to process a second image frame of the sequence of image frames to generate second encoder output data. The one or more processors are configured to, based on a comparison of the first image frame and the second image frame, determine whether to store the second encoder output data for image-based cognitive analysis.

### I. CROSS-REFERENCE TO RELATED APPLICATIONS

The present application claims priority from Provisional Patent Application No. 63/764,233, filed Feb. 27, 2025, and entitled “SELECTIVE STORAGE OR TRANSMISSION OF VISION ENCODER OUTPUT,” which is incorporated herein by reference in its entirety.

### II. FIELD

The present disclosure is generally related to vision encoding.

### III. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to capture image frames from a camera. The image frames can be used as input for further analysis, such as generating responses to image-related queries. A computing device typically has limited storage capacity that restricts the number of image frames that can be retained for later use. Transmitting the image frames to another device that may have more storage capacity for analysis can use significant bandwidth.

### IV. SUMMARY

According to one implementation of the present disclosure, a device includes a memory configured to store sets of encoder output data. The device also includes one or more processors coupled to the memory and configured to add, to the memory, first encoder output data for image-based cognitive analysis, the first encoder output data representing a first image frame of a sequence of image frames. The one or more processors are configured to use a vision encoder to process a second image frame of the sequence of image frames to generate second encoder output data. The one or more processors are configured to, based on a comparison of the first image frame and the second image frame, determine whether to store the second encoder output data for image-based cognitive analysis.

According to another implementation of the present disclosure, a device includes a memory configured to store sets of encoder output data. The device also includes one or more processors configured to add, to the memory, first encoder output data for image-based cognitive analysis, the first encoder output data representing a first image frame of a sequence of image frames. The one or more processors are configured to use a vision encoder to process a second image frame of the sequence of image frames to generate second encoder output data. The one or more processors are configured to, based on a comparison of the first encoder output data and the second encoder output data, determine whether to store the second encoder output data for image-based cognitive analysis.

According to another implementation of the present disclosure, a device includes a memory configured to store sets of encoder output data. The device also includes one or more processors coupled to the memory and configured to initiate transmission of first encoder output data for image-based cognitive analysis, the first encoder output data representing a first image frame of a sequence of image frames. The one or more processors are configured to use a vision encoder to process a second image frame of the sequence of image frames to generate second encoder output data. The one or more processors are configured to, based on a comparison of the first image frame and the second image frame, determine whether to initiate transmission of the second encoder output data for the image-based cognitive analysis.

According to another implementation of the present disclosure, a device includes a memory configured to store sets of encoder output data. The device also includes one or more processors coupled to the memory and configured to initiate transmission of first encoder output data for image-based cognitive analysis, the first encoder output data representing a first image frame of a sequence of image frames. The one or more processors are configured to use a vision encoder to process a second image frame of the sequence of image frames to generate second encoder output data. The one or more processors are configured to, based on a comparison of the first encoder output data and the second encoder output data, determine whether to initiate transmission of the second encoder output data for image-based cognitive analysis.

According to another implementation of the present disclosure, a device includes a memory configured to store sets of encoder output data. The device also includes one or more processors coupled to the memory and configured to receive, from a second device, first encoder output data for image-based cognitive analysis, the first encoder output data representing a first image frame of a sequence of image frames. The one or more processors are configured to add the first encoder output data to the memory. The one or more processors are configured to receive, from the second device, second encoder output data for image-based cognitive analysis, the second encoder output data representing a second image frame of the sequence of image frames. The one or more processors are configured to, based on a comparison of the first encoder output data and the second encoder output data, determine whether to store the second encoder output data for image-based cognitive analysis.

According to another implementation of the present disclosure, a method includes adding, to a memory, first encoder output data for image-based cognitive analysis, the first encoder output data representing a first image frame of a sequence of image frames. The method also includes using a vision encoder to process a second image frame of the sequence of image frames to generate second encoder output data. The method also includes, based on a comparison of the first image frame and the second image frame, determining whether to store the second encoder output data for image-based cognitive analysis.

According to another implementation of the present disclosure, a method includes adding, to a memory, first encoder output data for image-based cognitive analysis, the first encoder output data representing a first image frame of a sequence of image frames. The method also includes using a vision encoder to process a second image frame of the sequence of image frames to generate second encoder output data. The method also includes, based on a comparison of the first encoder output data and the second encoder output data, determining whether to store the second encoder output data for image-based cognitive analysis.

According to another implementation of the present disclosure, a method includes initiating transmission of first encoder output data for image-based cognitive analysis, the first encoder output data representing a first image frame of a sequence of image frames. The method also includes using a vision encoder to process a second image frame of the sequence of image frames to generate second encoder output data. The method also includes, based on a comparison of the first image frame and the second image frame, determining whether to initiate transmission of the second encoder output data for the image-based cognitive analysis.

According to another implementation of the present disclosure, a method includes initiating transmission of first encoder output data for image-based cognitive analysis, the first encoder output data representing a first image frame of a sequence of image frames. The method also includes using a vision encoder to process a second image frame of the sequence of image frames to generate second encoder output data. The method also includes, based on a comparison of the first encoder output data and the second encoder output data, determining whether to initiate transmission of the second encoder output data for image-based cognitive analysis.

According to another implementation of the present disclosure, a method includes receiving, at a first device from a second device, first encoder output data for image-based cognitive analysis, the first encoder output data representing a first image frame of a sequence of image frames. The method also includes adding the first encoder output data to a memory. The method also includes receiving, at a first device from the second device, second encoder output data for image-based cognitive analysis, the second encoder output data representing a second image frame of the sequence of image frames. The method also includes, based on a comparison of the first encoder output data and the second encoder output data, determining whether to store the second encoder output data for image-based cognitive analysis.

According to another implementation of the present disclosure, a non-transitory computer-readable medium stores instructions that, when executed by one or more processors, cause the one or more processors to add, to a memory, first encoder output data for image-based cognitive analysis, the first encoder output data representing a first image frame of a sequence of image frames. The instructions further cause the one or more processors to use a vision encoder to process a second image frame of the sequence of image frames to generate second encoder output data. The instructions further cause the one or more processors to, based on a comparison of the first image frame and the second image frame, determine whether to store the second encoder output data for image-based cognitive analysis.

According to another implementation of the present disclosure, a non-transitory computer-readable medium stores instructions that, when executed by one or more processors, cause the one or more processors to add, to a memory, first encoder output data for image-based cognitive analysis, the first encoder output data representing a first image frame of a sequence of image frames. The instructions further cause the one or more processors to use a vision encoder to process a second image frame of the sequence of image frames to generate second encoder output data. The instructions further cause the one or more processors to, based on a comparison of the first encoder output data and the second encoder output data, determine whether to store the second encoder output data for image-based cognitive analysis.

According to another implementation of the present disclosure, a non-transitory computer-readable medium stores instructions that, when executed by one or more processors, cause the one or more processors to initiate transmission of first encoder output data for image-based cognitive analysis, the first encoder output data representing a first image frame of a sequence of image frames. The instructions further cause the one or more processors to use a vision encoder to process a second image frame of the sequence of image frames to generate second encoder output data. The instructions further cause the one or more processors to, based on a comparison of the first image frame and the second image frame, determine whether to initiate transmission of the second encoder output data for the image-based cognitive analysis.

According to another implementation of the present disclosure, a non-transitory computer-readable medium stores instructions that, when executed by one or more processors, cause the one or more processors to initiate transmission of first encoder output data for image-based cognitive analysis, the first encoder output data representing a first image frame of a sequence of image frames. The instructions further cause the one or more processors to use a vision encoder to process a second image frame of the sequence of image frames to generate second encoder output data. The instructions further cause the one or more processors to, based on a comparison of the first encoder output data and the second encoder output data, determine whether to initiate transmission of the second encoder output data for image-based cognitive analysis.

According to another implementation of the present disclosure, a non-transitory computer-readable medium stores instructions that, when executed by one or more processors, cause the one or more processors to receive, from a device, first encoder output data for image-based cognitive analysis, the first encoder output data representing a first image frame of a sequence of image frames. The instructions further cause the one or more processors to add the first encoder output data to a memory. The instructions further cause the one or more processors to receive, from the device, second encoder output data for image-based cognitive analysis, the second encoder output data representing a second image frame of the sequence of image frames. The instructions further cause the one or more processors to, based on a comparison of the first encoder output data and the second encoder output data, determine whether to store the second encoder output data for image-based cognitive analysis.

According to another implementation of the present disclosure, an apparatus includes means for adding, to a memory, first encoder output data for image-based cognitive analysis, the first encoder output data representing a first image frame of a sequence of image frames. The apparatus further includes means for using a vision encoder to process a second image frame of the sequence of image frames to generate second encoder output data. The apparatus further includes means for determining, based on a comparison of the first image frame and the second image frame, whether to store the second encoder output data for image-based cognitive analysis.

According to another implementation of the present disclosure, an apparatus includes means for adding, to a memory, first encoder output data for image-based cognitive analysis, the first encoder output data representing a first image frame of a sequence of image frames. The apparatus further includes means for using a vision encoder to process a second image frame of the sequence of image frames to generate second encoder output data. The apparatus further includes means for determining, based on a comparison of the first encoder output data and the second encoder output data, whether to store the second encoder output data for image-based cognitive analysis.

According to another implementation of the present disclosure, an apparatus includes means for initiating transmission of first encoder output data for image-based cognitive analysis, the first encoder output data representing a first image frame of a sequence of image frames. The apparatus further includes means for using a vision encoder to process a second image frame of the sequence of image frames to generate second encoder output data. The apparatus further includes means for determining, based on a comparison of the first image frame and the second image frame, whether to initiate transmission of the second encoder output data for the image-based cognitive analysis.

According to another implementation of the present disclosure, an apparatus includes means for initiating transmission of first encoder output data for image-based cognitive analysis, the first encoder output data representing a first image frame of a sequence of image frames. The apparatus further includes means for using a vision encoder to process a second image frame of the sequence of image frames to generate second encoder output data. The apparatus further includes means for determining, based on a comparison of the first encoder output data and the second encoder output data, whether to initiate transmission of the second encoder output data for image-based cognitive analysis.

According to another implementation of the present disclosure, an apparatus includes means for receiving, from a device, first encoder output data for image-based cognitive analysis, the first encoder output data representing a first image frame of a sequence of image frames. The apparatus further includes means for adding the first encoder output data to a memory. The apparatus further includes means for receiving, from the device, second encoder output data for image-based cognitive analysis, the second encoder output data representing a second image frame of the sequence of image frames. The apparatus further includes means for determining, based on a comparison of the first encoder output data and the second encoder output data, whether to store the second encoder output data for image-based cognitive analysis.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1A is a block diagram of a particular illustrative example of a system operable to perform selective storage of vision encoder output, in accordance with some examples of the present disclosure.

FIG. 1B is a diagram of an illustrative example of a hierarchical vision encoder, in accordance with some examples of the present disclosure.

FIG. 1C is a diagram of an illustrative example of an image-based cognitive analyzer, in accordance with some examples of the present disclosure.

FIG. 2 is a diagram of an illustrative example of a system operable to perform selective transmission of vision encoder output, in accordance with some examples of the present disclosure.

FIG. 3 is a diagram of an illustrative example of a system operable to perform selective storage of vision encoder output at a recipient device, in accordance with some examples of the present disclosure.

FIG. 4 illustrates an example of an integrated circuit operable to perform selective storage, selective transmission, or both, of vision encoder output, in accordance with some examples of the present disclosure.

FIG. 5 is a diagram of a mobile device operable to perform selective storage, selective transmission, or both, in accordance with some examples of the present disclosure.

FIG. 6 is a diagram of a wearable electronic device operable to perform selective storage, selective transmission, or both, in accordance with some examples of the present disclosure.

FIG. 7 is a diagram of a mixed reality or augmented reality glasses device operable to perform selective storage, selective transmission, or both, in accordance with examples of the present disclosure.

FIG. 8 is a diagram of a voice-controlled speaker system operable to perform selective storage, selective transmission, or both, in accordance with some examples of the present disclosure.

FIG. 9 is a diagram of a camera operable to perform selective storage, selective transmission, or both, in accordance with some examples of the present disclosure.

FIG. 10 is a diagram of a headset, such as a virtual reality, mixed reality, or augmented reality headset, operable to perform selective storage, selective transmission, or both, in accordance with some examples of the present disclosure.

FIG. 11 is a diagram of a first example of a vehicle operable to perform selective storage, selective transmission, or both, in accordance with some examples of the present disclosure.

FIG. 12 is a diagram of a second example of a vehicle operable to perform selective storage, selective transmission, or both, in accordance with some examples of the present disclosure.

FIG. 13 is a diagram of a particular implementation of a method of selective storage of vision encoder output that may be performed by the device of FIG. 1A, in accordance with some examples of the present disclosure.

FIG. 14 is a diagram of a particular implementation of another method of selective storage of vision encoder output that may be performed by the device of FIG. 1A, in accordance with some examples of the present disclosure.

FIG. 15 is a diagram of a particular implementation of a method of selective transmission of vision encoder output that may be performed by a device of FIG. 2, in accordance with some examples of the present disclosure.

FIG. 16 is a diagram of a particular implementation of another method of selective transmission of vision encoder output that may be performed by the device of FIG. 2, in accordance with some examples of the present disclosure.

FIG. 17 is a diagram of a particular implementation of a method of selective storage of vision encoder output that may be performed by a device of FIG. 3, in accordance with some examples of the present disclosure.

FIG. 18 is a block diagram of a particular illustrative example of a device that is operable to perform selective storage, selective transmission, or both, in accordance with some examples of the present disclosure.

### VI. DETAILED DESCRIPTION

Cognitive analysis can be performed on image frames, such as to generate responses to image-related queries. Limited storage capacity at a device can restrict the number of image frames that can be stored and made available for further analysis. Transmitting the image frames to another device that may have more storage capacity for analysis can use significant bandwidth.

Systems and methods of selective storage or selective transmission of vision encoder output are disclosed. For example, a vision encoder (e.g., a hierarchical vision encoder (HVE)) processes an image frame to generate encoder output data that represents the image frame for cognitive analysis. In an illustrative example, using a first stage of the HVE, an image frame is processed to generate first image latent data that corresponds to a first downscaled representation of the image frame. A second stage of the HVE processes the first image latent data to generate second image latent data that corresponds to a second downscaled representation of the image frame. For example, the second downscaled representation corresponds to additional downscaling of the first downscaled representation. Each subsequent stage of the HVE processes previous image latent data generated by a prior stage of the HVE to generate image latent data that corresponds to an additionally downscaled representation of the image frame. The HVE outputs image latent data generated by one or more stages as encoder output data. In an example, the HVE includes a convolutional neural network (CNN) and each stage of the HVE corresponds to a respective convolutional layer of the CNN.

The encoder output data is added to image analysis data stored in a memory. In some examples, the encoder output data is added to image analysis data stored in a local memory, transmitted to another device, or both. Subsequently, when cognitive analysis based on the image frame is to be performed, the encoder output data representing the image frame is retrieved from the memory and processed to generate a response to an image-related query.

The encoder output data typically has a smaller size than the original image frame. For example, fewer bits are used to store the encoder output data in the memory than bits that would be used to store the original image frame. Therefore, the encoder output data corresponding to a greater number of image frames can be stored in the memory more efficiently than storing the image frames themselves. Additionally, the encoder output data can be transmitted more efficiently than transmitting the image frames themselves. Consequently, data from a greater number of image frames becomes accessible for cognitive analysis.

In an example, a vision encoder (e.g., an HVE) at a first device processes a first image frame of a sequence of image frames to generate first encoder output data, and processes a second image frame of the sequence of image frames to generate second encoder output data. In some examples, a storage manager of the first device adds the first encoder output data to a memory and selectively adds the second encoder output data to the memory. For example, the storage manager determines whether to store the second encoder output data based on a comparison of the first image frame and the second image frame or a comparison of the first encoder output data and the second encoder output data. To illustrate, if the second image frame is similar to the first image frame or the second encoder output data is similar to the first encoder output data, the second encoder output data can be discarded and resources (e.g., memory) can be conserved.

In some examples, a transmission manager of the first device initiates transmission of the first encoder output data to a second device and selectively initiates transmission of the second encoder output data to the second device. For example, the transmission manager determines whether to transmit the second encoder output data based on a comparison of the first image frame and the second image frame or a comparison of the first encoder output data and the second encoder output data. To illustrate, if the second image frame is similar to the first image frame or the second encoder output data is similar to the first encoder output data, the second encoder output data can be discarded and resources (e.g., bandwidth) can be conserved.

In some examples, a storage manager of a second device stores the first encoder output data received from the first device, and selectively stores the second encoder output data received from the first device. For example, the storage manager determines whether to store the second encoder output data based on a comparison of the first encoder output data and the second encoder output data. To illustrate, if the second encoder output data is similar to the first encoder output data, the second encoder output data can be discarded and resources (e.g., memory) can be conserved.

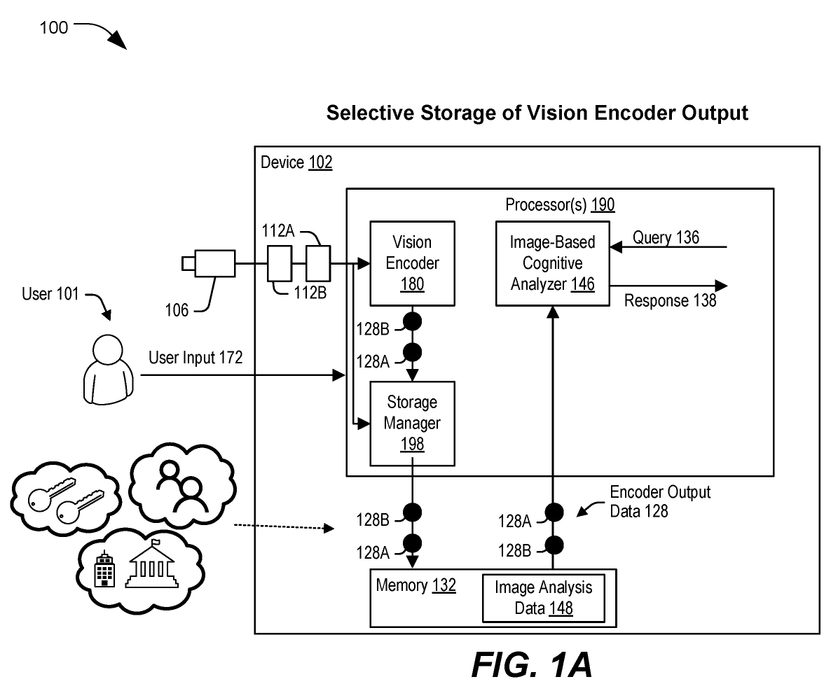

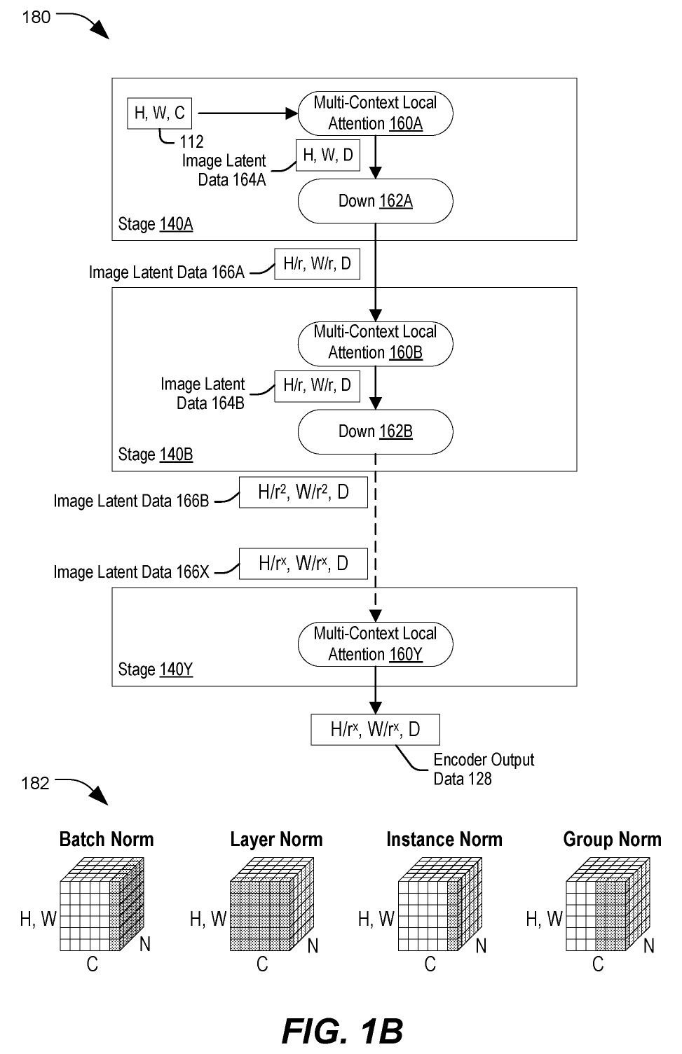

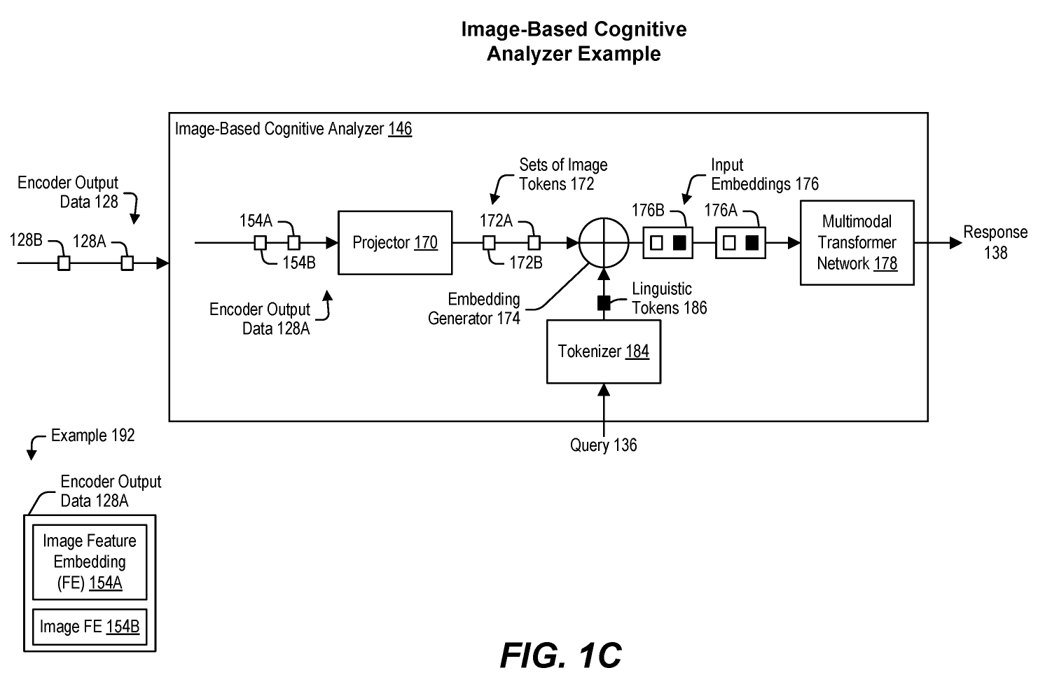

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1A depicts a device 102 including one or more processors (“processor(s)” 190 of FIG. 1A), which indicates that in some implementations the device 102 includes a single processor 190 and in other implementations the device 102 includes multiple processors 190. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1A, multiple image frames are illustrated and associated with reference numbers 112A and 112B. When referring to a particular one of these image frames, such as an image frame 112A, the distinguishing letter “A” is used. However, when referring to any arbitrary one of these image frames or to these image frames as a group, the reference number 112 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, receiving, or accessing the parameter (or signal) that is already generated, such as by another component or device.

As used herein, the term “latent data” should be understood in accordance with any of its usual and customary meanings in the fields of computer science, data science, and/or machine learning. For example, latent data can be generated by a machine-learning model as a representation of data input to the machine-learning model. Generally, the latent data include values representing underlying patterns, structures, or features that the machine-learning model infers from the input data. Ideally, the latent data represents the input data in a manner that includes important and/or unique characteristics of the input data in view of a goal or purpose of the machine-learning model. To illustrate, image latent data described herein includes latent data representing characteristics of one or more images in a manner that is useful for image-based cognitive analysis.

As used herein, the term “hierarchical vision encoder” should be understood in accordance with any of its usual and customary meanings in the fields of computer science, data science, and/or machine learning. Generally, a hierarchical vision encoder corresponds to an encoder that includes at least two stages and is configured to process image data in a hierarchical manner (e.g., output of one stage is provided as input, possibly along with other data, to a subsequent stage). To illustrate, a hierarchical vision encoder described herein includes at least a first stage and a second stage. The first stage is configured to process image data of an image frame to generate first stage output (e.g., first image latent data) corresponding to a representation (e.g., a downscaled representation) of the image frame. The second stage is configured to process the first stage output (e.g., the first image latent data) to generate second stage output (e.g., second image latent data) corresponding to a representation (e.g., an additionally downscaled representation) of the image frame. The hierarchical vision encoder is configured to generate encoder output data that is based on output of one or more of the stages.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows – a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

Referring to FIG. 1A, a particular illustrative aspect of a system configured to perform selective storage of vision encoder output is disclosed and generally designated 100. The system 100 includes a device 102 that includes one or more processors 190 coupled to a memory 132. The one or more processors 190 are also coupled to an image source 106. The one or more processors 190 include a vision encoder 180 (e.g., a hierarchical vision encoder (HVE)), a storage manager 198, and optionally an image-based cognitive analyzer 146. The memory 132 is coupled to the storage manager 198 and optionally to the image-based cognitive analyzer 146. It should be understood that the image-based cognitive analyzer 146 is provided as an illustrative example of an image-based analyzer configured to process encoder output data of the vision encoder 180; in other examples the device 102 can include one or more other types of image-based analyzers configured to process encoder output data of the vision encoder 180.

The image source 106 is depicted as a video camera external to the device 102 as an illustrative example, in some other examples, the image source 106 can be integrated into the device 102. In some examples, the image source 106 can include various types of image sources, such as a still camera, a synthetic image generation device (e.g., a graphical processing unit (GPU)), a network device, a storage device, a communication device, or a combination thereof. The image source 106 is configured to provide a sequence of image frames 112 to the one or more processors 190. In a particular aspect, the sequence of image frames 112 includes an image frame 112A, an image frame 112B, one or more additional image frames, or a combination thereof.

The vision encoder 180 is configured to process an image frame 112 to generate encoder output data 128. In some aspects, the encoder output data 128 corresponds to a downscaled representation of the image frame 112, as further described with reference to FIG. 1B. For example, the vision encoder 180 corresponds to an HVE that includes a plurality of stages. An initial stage is configured to process an image frame 112 to generate first image latent data corresponding to a downscaled representation of the image frame 112. Each subsequent stage is configured to process previous image latent data generated by a prior stage to generate subsequent image latent data. The previous image latent data corresponds to a representation of a previous image frame (e.g., a downscaled version of the image frame 112) and the subsequent image latent data corresponds to a downscaled representation of the previous image frame (e.g., an additionally downscaled version of the image frame 112). A last stage is configured to process image latent data generated by a prior stage to generate the encoder output data 128. Optionally, in some embodiments, the vision encoder 180 includes a convolutional neural network (CNN), and a particular convolutional layer of the CNN corresponds to a respective stage of the vision encoder 180. It should be understood that an HVE and a CNN are provided as illustrative examples of the vision encoder 180; in other examples the vision encoder 180 can include other types of image encoders. The encoder output data 128 represents the image frames 112. In some examples, an image frame 112 can depict sensitive information, people, homes, offices, etc., and storing or transmitting the encoder output data 128 instead of the image frames 112 enhances security.

The storage manager 198 is configured to selectively store encoder output data 128 in the memory 132. For example, the storage manager 198 is configured to, based on a comparison of image frames or a comparison of encoder output data of the image frames, determine whether to add encoder output data to the memory 132. To illustrate, the storage manager 198 is configured to store encoder output data 128A of an image frame 112A in the memory 132. The storage manager 198 is configured to, based on a comparison of the image frame 112A and the image frame 112B or a comparison of the encoder output data 128A and the encoder output data 128B, determine whether to store the encoder output data 128B in the memory 132. In some aspects, selectively adding to encoder output data 128 to the memory 132 corresponds to selectively adding the encoder output data 128 to image analysis data 148 stored in the memory 132. The image analysis data 148 is used to represent the sequence of image frames 112 for image-based cognitive analysis.

The image-based cognitive analyzer 146 is configured to use encoder output data 128 to perform image-based cognitive analysis. For example, the image-based cognitive analyzer 146 is configured to process encoder output data 128 of one or more image frames 112 to generate a response 138 to a query 136, as further described with reference to FIG. 1C. To illustrate, the image-based cognitive analyzer 146 is configured to generate image tokens based on the encoder output data 128, generate linguistic tokens based on the query 136, generate an input embedding based on the image tokens and the linguistic tokens, and use a large language model (LLM) to process the input embedding to generate the response 138.

The memory 132 is configured to store data used or generated by one or more components of the device 102. For example, the memory 132 is configured to store one or more of an image frame 112, encoder output data 128, image analysis data 148, the query 136, the response 138, or additional data. In some aspects, the memory 132 includes an image buffer, a data transmission buffer, a data receipt buffer, or a combination thereof.

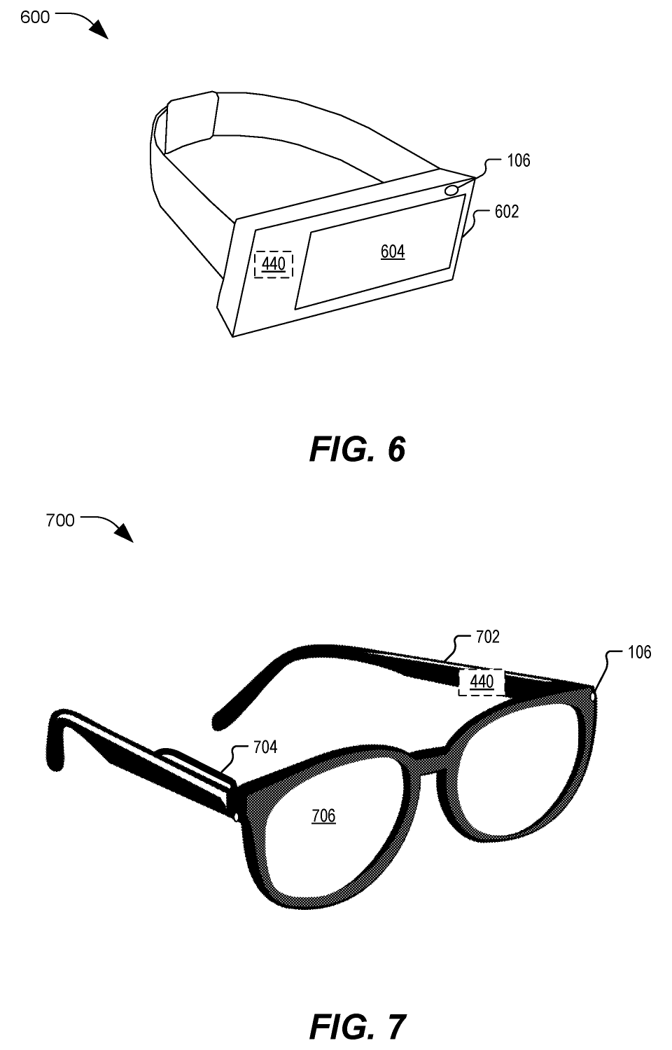

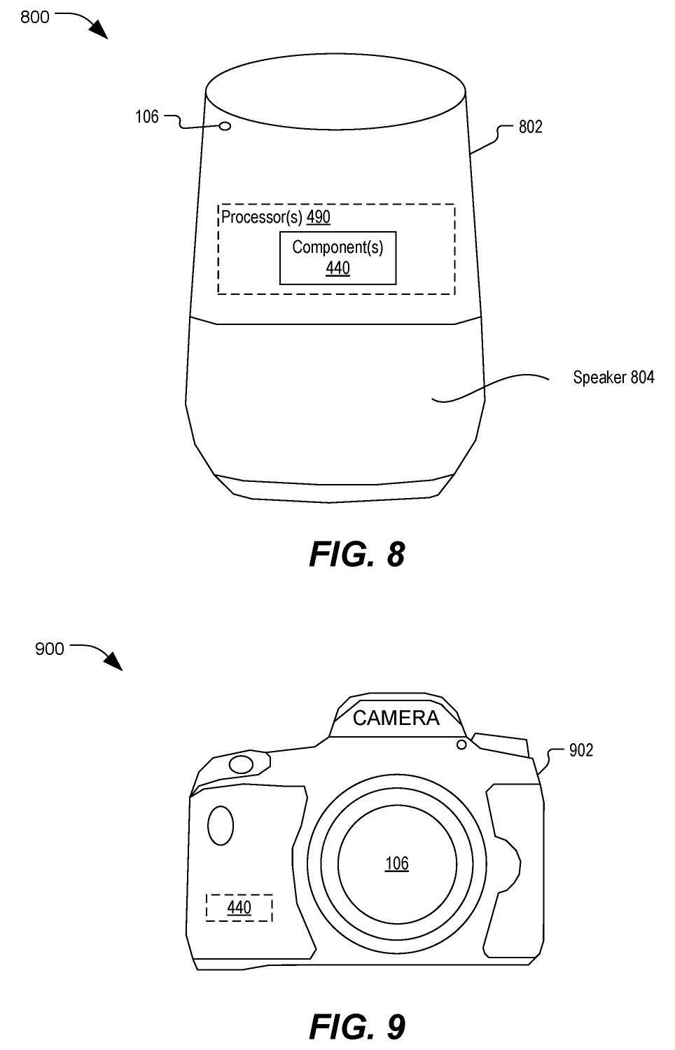

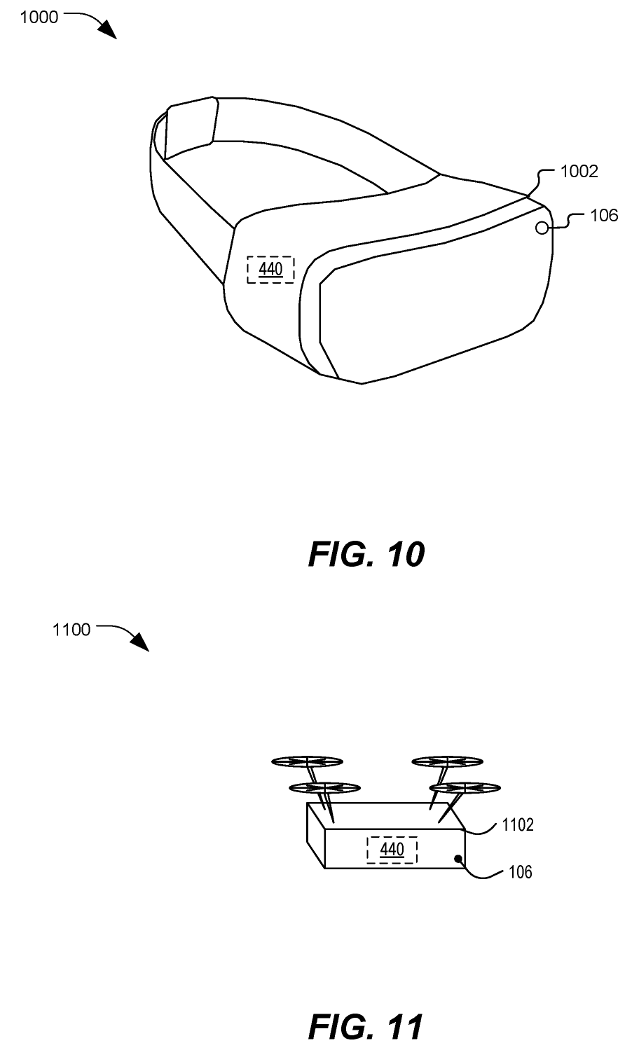

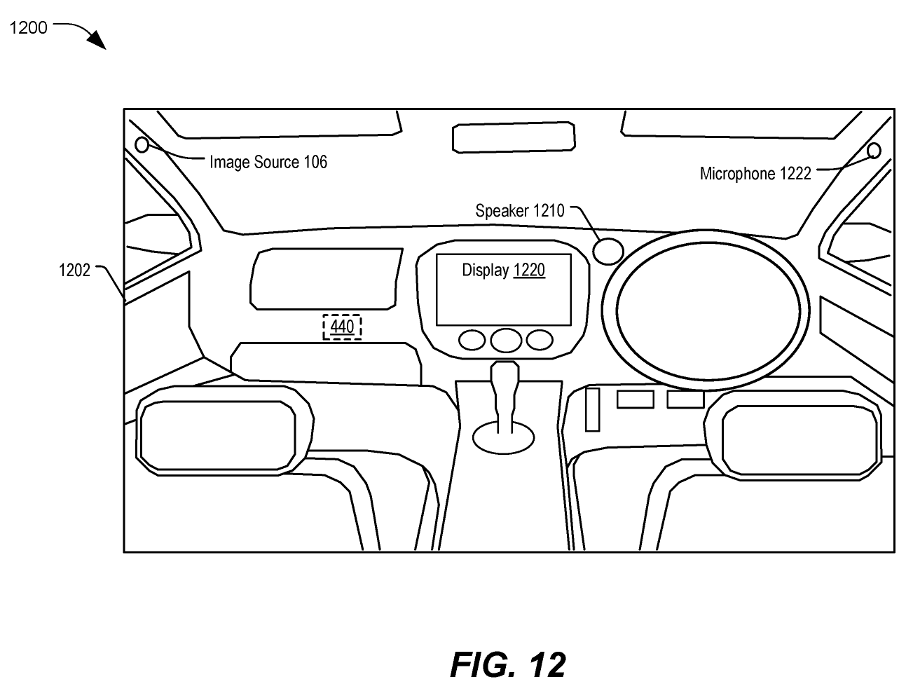

In some embodiments, the device 102 corresponds to or is included in one of various types of devices. In an illustrative example, the one or more processors 190 are integrated in at least one of a mobile phone or a tablet computer device, as described with reference to FIG. 5, a wearable electronic device, as described with reference to FIG. 6, a mixed reality or augmented reality glasses device, as described with reference to FIG. 7, a voice-controlled speaker system, as described with reference to FIG. 8, a camera device, as described with reference to FIG. 9, or a virtual reality, mixed reality, or augmented reality headset, as described with reference to FIG. 10. In another illustrative example, the one or more processors 190 are integrated into a vehicle, such as described further with reference to FIG. 11 and FIG. 12.

During operation, the image source 106 (e.g., a phone camera) of a user 101 provides an image frame 112A of a sequence of image frames 112 to the vision encoder 180, and optionally to the storage manager 198. In a particular aspect, the storage manager 198, responsive to receiving the image frame 112A, stores the image frame 112A in the memory 132.

The vision encoder 180 processes the image frame 112A to generate encoder output data 128A corresponding to a representation (e.g., a downscaled representation) of the image frame 112A, as further described with reference to FIG. 1B. In some aspects, the encoder output data 128A includes a plurality of image feature embeddings that correspond to the downscaled representation of the image frame 112A. In some examples, the encoder output data 128A includes image encoding data (e.g., a set of identifiers) that is based on the plurality of image feature embeddings. The storage manager 198 stores the encoder output data 128A in the memory 132. For example, the storage manager 198 adds the encoder output data 128A to image analysis data 148 used to represent the sequence of image frames 112 for image-based cognitive analysis. The image analysis data 148 is stored in the memory 132.

In a particular aspect, the encoder output data 128A is designated as associated with (e.g., representative of) the image frame 112A. In an example, the encoder output data 128A is designated as associated with a timestamp of the image frame 112A, a location of the image source 106 when the image frame 112A is captured, a user identifier of a user 101 that is logged into the device 102 when the image frame 112A is obtained, or a combination thereof.

Optionally, in some embodiments, the vision encoder 180, subsequent to processing the image frame 112A to generate the encoder output data 128A, discards the image frame 112A. To illustrate, the image frame 112A is stored in the memory 132 (e.g., an image buffer) and the vision encoder 180 marks the image frame 112A for deletion from the memory 132.

In some aspects, similar operations are performed to process additional image frames of the sequence of image frames 112. For example, the image source 106 provides an image frame 112B of the sequence of image frames 112 to the vision encoder 180, and optionally to the storage manager 198. The storage manager 198, responsive to receiving the image frame 112B, stores the image frame 112B in the memory 132.

The vision encoder 180 processes the image frame 112B to generate encoder output data 128B and provides the encoder output data 128B to the storage manager 198. Optionally, in some embodiments, the vision encoder 180 selectively processes the image frame 112B to generate the encoder output data 128B. For example, the vision encoder 180, based on a comparison of the image frame 112A and the image frame 112B, determines whether to process the image frame 112B. To illustrate, the vision encoder 180, based on determining that differences between the image frame 112A and the image frame 112B fail to satisfy an encoder difference threshold, refrains from processing the image frame 112B and discards the image frame 112B. Alternatively, the vision encoder 180, based on determining that the differences between the image frame 112A and the image frame 112B satisfy the encoder difference threshold, processes the image frame 112B to generate the encoder output data 128B.

Optionally, in some embodiments, the vision encoder 180, based on determining that the image frame 112A is processed to generate the encoder output data 128A at a first time and determining that an elapsed time (e.g., a difference, at a second time, between the first time and the second time) since the first time satisfies (e.g., is greater than) an encoder time threshold, processes the image frame 112B to generate the encoder output data 128B. To illustrate, if the elapsed time since the image frame 112A is processed to generate encoder output data 128A (e.g., most recently processed image frame) is greater than the encoder time threshold, the image frame 112B is processed to generate the encoder output data 128B independently of the difference between the image frame 112A and the image frame 112B.

Optionally, in some embodiments, the vision encoder 180, based on determining that a count of image frames of the sequence of image frames 112 between the image frame 112A and the image frame 112B satisfies an encoder frame count threshold, processes the image frame 112B to generate the encoder output data 128B. To illustrate, if the image frame count since the image frame 112A (e.g., most recently processed image frame) is greater than the encoder frame count threshold, the image frame 112B is processed to generate the encoder output data 128B independently of the difference between the image frame 112A and the image frame 112B.

The storage manager 198 selectively adds the encoder output data 128B to the image analysis data 148 stored in the memory 132. Optionally, in some embodiments, the storage manager 198 retrieves the image frame 112A and the image frame 112B from the memory 132 and determines whether to store the encoder output data 128B based on a comparison of the image frame 112A and the image frame 112B. To illustrate, the storage manager 198, based on determining that a difference between the image frame 112A and the image frame 112B satisfies (e.g., is greater than) a storage threshold, stores the encoder output data 128B in the memory 132. Alternatively, the storage manager 198, based on determining that the difference between the image frame 112A and the image frame 112B fails to satisfy (e.g., is less than or equal to) the storage threshold, refrains from storing the encoder output data 128B in the memory 132. For example, the storage manager 198 refrains from adding the encoder output data 128B to the image analysis data 148, discards the encoder output data 128B, discards the image frame 112B, or a combination thereof.

Optionally, in some embodiments, the storage manager 198 retrieves the encoder output data 128A from the image analysis data 148 stored in the memory 132 and determines whether to store the encoder output data 128B based on a comparison of the encoder output data 128A and the encoder output data 128B. To illustrate, the storage manager 198, based on determining that a difference between the encoder output data 128A and the encoder output data 128B satisfies (e.g., is greater than) a storage threshold, stores the encoder output data 128B in the memory 132. Alternatively, the storage manager 198, based on determining that the difference between the encoder output data 128A and the encoder output data 128B fails to satisfy (e.g., is less than or equal to) the storage threshold, refrains from storing the encoder output data 128B in the memory 132. For example, the storage manager 198 refrains from adding the encoder output data 128B to the image analysis data 148, discards the encoder output data 128B, discards the image frame 112B, or a combination thereof.

Optionally, in some embodiments, the storage manager 198, based on determining that the encoder output data 128A is added to the memory 132 at a first time and determining that an elapsed time (e.g., a difference, at a second time, between the first time and the second time) since the first time satisfies (e.g., is greater than) a storage time threshold, stores the encoder output data 128B to the image analysis data 148 in the memory 132. To illustrate, if the elapsed time since the encoder output data 128A (e.g., most recently stored encoder output data) is greater than the storage time threshold, the encoder output data 128B is added to the memory 132 independently of the difference between the image frame 112A and the image frame 112B and the difference between the encoder output data 128A and the encoder output data 128B.

Optionally, in some embodiments, the storage manager 198, based on determining that a count of image frames of the sequence of image frames 112 between the image frame 112A and the image frame 112B satisfies a storage frame count threshold, stores the encoder output data 128B to the image analysis data 148 in the memory 132. To illustrate, if the image frame count since the image frame 112A corresponding to the encoder output data 128A (e.g., most recently stored encoder output data) is greater than the storage frame count threshold, the encoder output data 128B is added to the memory 132 independently of the difference between the image frame 112A and the image frame 112B and the difference between the encoder output data 128A and the encoder output data 128B.

Optionally, in some implementations, the storage manager 198, responsive to storing the encoder output data 128B in the memory 132, removes the image frame 112A, from the memory 132. In an example, the storage manager 198 retains the image frame 112B corresponding to most recently stored encoder output data to perform selective storage of next encoder output data based on image frame comparison.

Subsequently, the image-based cognitive analyzer 146 receives a query 136 related to the sequence of image frames 112. In a particular aspect, the image-based cognitive analyzer 146 receives, from a user 101, user input 172 indicating the query 136. In some aspects, the query 136 indicates a set of image frames 112 of interest. For example, the query 136 (e.g., “where did I leave my keys in the last one hour?”) indicates a target time interval (e.g., captured in the last one hour) of the set of image frames 112 of interest. The image-based cognitive analyzer 146, based on determining that the query 136 is associated with one or more image frames 112, retrieves encoder output data 128 from the image analysis data 148 stored in the memory 132. For example, the image-based cognitive analyzer 146, based on determining that query 136 is associated with the image frame 112A, retrieves the encoder output data 128A from the memory 132 corresponding to the image frame 112A. As another example, the image - based cognitive analyzer 146, based on determining that the query 136 is associated with the image frame 112B and that the encoder output data 128B corresponding to the image frame 112B is not stored in the image analysis data 148, retrieves the encoder output data 128A corresponding to the image frame 112A (e.g., the most recent image frame 112 prior to the image frame 112B with encoder output data 128 available in the image analysis data 148).

The image-based cognitive analyzer 146 performs image-based cognitive analysis based on the encoder output data 128A to generate a response 138 to the query 136, as further described with reference to FIG. 1C. The image-based cognitive analysis includes processing linguistic inputs and image-based inputs using a multimodal transformer network. For example, the image-based cognitive analyzer 146 generates image tokens based on the encoder output data 128A and linguistic tokens based on the query 136, generates an input embedding based on the image tokens and the linguistic tokens, uses a multimodal transformer network (e.g., an LLM) to perform image-based cognitive analysis based on the input embedding to generate the response 138. The response 138 can include text, audio, or both. If the response 138 corresponds to an answer to the query 136 that is identified in the image frame 112A, the response 138 can indicate image-related data associated with the encoder output data 128A. For example, if the response 138 indicates that a queried object (e.g., the key) was most recently detected in the image frame 112A, the response 138 can indicate a time, a location, a user, or a combination thereof associated with the encoder output data 128A.

In a particular aspect, the image-based cognitive analyzer 146 outputs the response 138 to the user 101. In an example, the image-based cognitive analyzer 146 provides the response 138 to a display device, a communication device, a speaker, or a combination thereof.

A technical advantage of the system 100 includes accessibility to data associated with more image frames 112 for cognitive analysis. For example, the encoder output data 128A is smaller than the image frame 112A. With limited storage capacity, sets of encoder output data 128 corresponding to more image frames 112 can be stored in the memory 132 than original image frames 112.

Another technical advantage of the system 100 includes reduced memory usage without significant adverse impact to performance of the cognitive analysis. For example, the encoder output data 128B is selectively discarded to reduce memory usage if the encoder output data 128B is relatively similar to encoder output data 128A that has recently been stored.

In some examples, based on an output of the vision encoder 180, the image-based cognitive analyzer 146, a neural network, a machine-learning model, or a combination thereof, one or more components of a device (e.g., the device 102) can perform various operations such as: i) controlling a machine such as a vehicle, a robot, an appliance, a mobile device, a camera; ii) controlling an actuator such as an electromechanical actuator, an electrohydraulic actuator, an electroactive polymer actuator; iii) controlling an active circuit component such as a voltage or current source, a transistor, an amplifier, an integrated circuit, a programmable device such as field-programmable gate array (FPGA), a display device; iii) providing a notification to a user, such as a visual, auditory or haptic notification or combination thereof, iv) launching, closing, pausing or suspending an application on a computer; iv) launching, closing, pausing or suspending playback of audio video (AV) media on a computer; or v) providing a control signal to initiate any of the above.

Referring to FIG. 1B, an illustrative example of the vision encoder 180 is disclosed, in accordance with some examples of the present disclosure. The vision encoder 180 corresponds to an HVE that includes a plurality of stages 140, such as a stage 140A, a stage 140B, one or more additional stages 140, a stage 140Y, or a combination thereof. It should be understood that the vision encoder 180 is depicted as including 3 stages 140 as an illustrative example; in other examples the vision encoder 180 can include fewer than 3 or more than 3 stages 140.

Each stage 140 of the vision encoder 180 includes a multi-context local attention 160. For example, the stage 140A includes a multi-context local attention 160A, the stage 140B includes a multi-context local attention 160B, the stage 140Y includes a multi-context local attention 160Y, and so on. One or more of the stages 140 of the vision encoder 180 include a downscaling layer 162 (e.g., a pooling layer or a convolution layer). For example, the stage 140A includes a downscaling layer 162A, the stage 140B includes a downscaling layer 162B, and so on. In some embodiments, the last stage (e.g., the stage 140Y) does not include a downscaling layer 162.

The multi-context local attention 160A processes data representing an image frame 112 to generate image latent data 164A. In an example, a multi-context local attention 160 is configured to capture dependencies across different parts of an input. To illustrate, the multi-context local attention 160 performs feature extraction by integrating contextual information to generate image latent data 164.

The image frame 112 has a height (H), a width (W), and channels (C). The image latent data 164A includes first image feature embeddings representing the image frame 112 having the height (H) and the width (W). An image feature embedding has an embedding dimension (D) that indicates a count of features (e.g., numerical values) represented in the image feature embedding.

The downscaling layer 162A processes the image latent data 164A to generate image latent data 166A. The image latent data 166A includes second image feature embeddings that represent a downscaled representation of the image frame 112. For example, the downscaled representation has a height (H/r) and a width (W/r), where r corresponds to a downscaling factor. In some embodiments, a second image feature embedding of image latent data 166 has the same dimensionality (D) as a first image feature embedding of image latent data 164. In some embodiments, a count of the second image feature embeddings included in the image latent data 166 that is output by a downscaling layer 162 is fewer than a count of the first image feature embeddings included in the image latent data 164 input to the downscaling layer 162.

Optionally, in some embodiments, similar operations are performed at one or more intermediate stages 140 of the vision encoder 180 based on output of respective previous stages 140. For example, the multi-context local attention 160B processes the image latent data 166A to generate image latent data 164B. The downscaling layer 162B processes the image latent data 164B to generate image latent data 166B. The image latent data 166B includes third image feature embeddings that represent a downscaled representation of the image frame 112. For example, the downscaled representation has a height (H/r²) and a width (W/r²), where each of the downscaling layers 162A and 162B have the same downscaling factor (r). To illustrate, the third image feature embeddings of the image latent data 166B correspond to a downscaled representation of an image frame represented by the second image frame embeddings of the image latent data 166A. In some embodiments, a count of the third image feature embeddings included in the image latent data 166B that is output by the downscaling layer 162B is fewer than a count of the second image feature embeddings included in the image latent data 166A that is output by the downscaling layer 162A.

At the stage 140Y (e.g., a last stage of the stages 140), the multi-context local attention 160B processes the image latent data 166X (e.g., image latent data 166 generated by a previous stage 140) to generate the encoder output data 128. The encoder output data 128 corresponds to a downscaled representation of the image frame 112. In some aspects, the downscaled representation has a height (H/r^{x}) and a width (W/r^{x}), where x is a count of stages prior to the stage 140Y. In an example, the encoder output data 128 includes fourth image feature embeddings, and each image feature embedding has an embedding dimension (D). In some aspects, a count of the fourth image feature embeddings of the encoder output data 128 is fewer than a count of the first image feature embeddings of the image latent data 164A. For example, the fourth image feature embeddings correspond to a downscaled representation (e.g., an image frame having a height (H/r^{x}) and a width (W/r^{x})) as compared to the first image frame embeddings corresponding to the image frame 112 (e.g., having a height (H) and a width (W)).

It should be understood that a stage 140 can include one or more additional layers or components that are not shown, such as one or more of a normalization layer, a convolution layer, a pooling layer, etc. In an example 182, various types of normalizations are depicted, such as batch normalization, layer normalization, instance normalization, and group normalization. Height (H) and width (W) correspond to spatial dimensions of an image frame 112, C corresponds to channels in the image frame 112, and N corresponds to a batch size.

A technical advantage of the vision encoder 180 includes retaining characteristics of the image frames 112 in the encoder output data 128 with a reduced size, as compared to the original image frame 112 and also as compared to the image latent data 164A. The smaller size of the encoder output data 128 enables conservation of resources (e.g., memory, bandwidth, or both).

Referring to FIG. 1C, an illustrative example of the image-based cognitive analyzer 146 is disclosed, in accordance with some examples of the present disclosure. The image-based cognitive analyzer 146 includes a projector 170 and a tokenizer 184 that are each coupled to an embedding generator 174. The embedding generator 174 is coupled to a multimodal transformer network 178. In some aspects, the multimodal transformer network 178 corresponds to (e.g., includes) an LLM. In a particular aspect, the image-based cognitive analyzer 146 can be included in the device 102 of FIG. 1A.

During operation, the tokenizer 184 processes the query 136 to generate linguistic tokens 186 that represent the query 136 in a token space. In an example, the tokenizer 184 breaks up the query 136 into linguistic segments, such as subwords, words, characters, other types of segments, or a combination thereof. The tokenizer 184 outputs linguistic tokens 186 (e.g., numerical values) corresponding to the linguistic segments. To illustrate, a linguistic token 186 (e.g., a numerical value) represents a corresponding linguistic segment in the token space.

The image-based cognitive analyzer 146 receives the encoder output data 128A corresponding to the image frame 112A, as described with reference to FIG. 1A. In an example 192, the encoder output data 128A includes (or corresponds to) an image feature embedding (FE) 154A, an image FE 154B, one or more additional FEs, or a combination thereof. To illustrate, in a particular aspect, the encoder output data 128A includes image FEs 154. In another aspect, the encoder output data 128A includes image encoding data (e.g., a set of identifiers) and the image encoding data can be used to determine corresponding image FEs 154.

The projector 170 processes each image FE 154 to generate a corresponding set of image tokens 173. For example, the projector 170 processes the image FE 154A to generate a set of image tokens 173A, the image FE 154B to generate a set of image tokens 173B, and so on. A set of image tokens 173 represents a corresponding image FE 154 in a token space. In a particular aspect, the set of image tokens 173A and the linguistic tokens 186 are associated with the same token space and can be processed together by the multimodal transformer network 178.

The embedding generator 174 generates an input embedding 176A based on the set of image tokens 173A and the linguistic tokens 186. For example, the embedding generator 174 concatenates the set of image tokens 173A and the linguistic tokens 186 to generate the input embedding 176A. The multimodal transformer network 178 processes the input embedding 176A to generate the response 138. In a particular aspect, the response 138 includes a synthetic image, text, audio, or a combination thereof.

Similarly, the image-based cognitive analyzer 146 processes one or more additional image FEs 154 of the encoder output data 128A associated with the image frame 112A and continues to generate (e.g., update) the response 138. For example, the projector 170 processes the image FE 154B to generate a set of image tokens 173B. The embedding generator 174 generates an input embedding 176B based on the set of image tokens 173B and the linguistic tokens 186. The multimodal transformer network 178 processes the input embedding 176B to generate (e.g., update) the response 138.

In a particular aspect, the image-based cognitive analyzer 146 processes encoder output data 128 corresponding to one or more additional image frames 112 and continues to generate (e.g., update) the response 138. For example, the image-based cognitive analyzer 146 processes the encoder output data 128B corresponding to the image frame 112B to generate (e.g., update) the response 138.

A technical advantage of the image-based cognitive analyzer 146 includes enabling generation of a response 138 to the query 136 based on the encoder output data 128 that represents image features of downsampled representations of the image frames 112 without having access to the original image frames 112. For example, the vision encoder 180 of FIG. 1A can process an image frame 112A to generate the encoder output data 128A and the image frame 112A can be discarded. The encoder output data 128A can be used to generate the response 138.

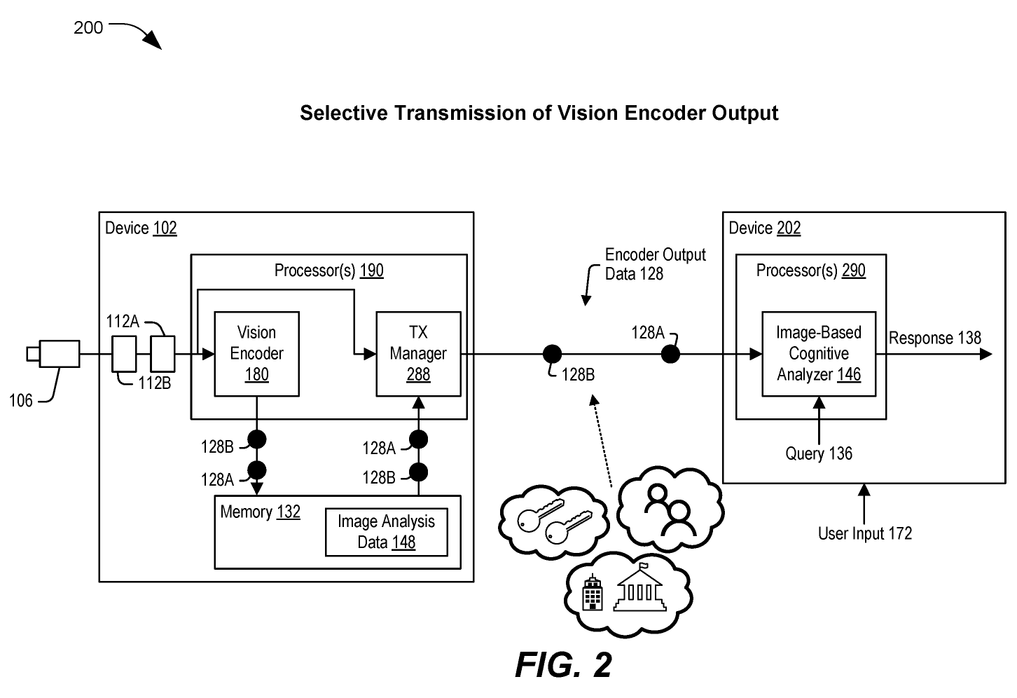

Referring to FIG. 2, a particular illustrative aspect of a system configured to perform selective transmission of vision encoder output is disclosed and generally designated 200, in accordance with some examples of the present disclosure. The system 200 includes the device 102 coupled to one or more devices 202.

A device 202 includes one or more processors 290 that include the image-based cognitive analyzer 146. The vision encoder 180 and a transmission (TX) manager 288 are included in the one or more processors 190 of the device 102. In a non-limiting illustrative example, the device 102 can correspond to extended reality (XR) glasses and the device 202 can correspond to a companion device (e.g., a phone, a gaming system, a network device, a server, or a combination thereof) that has more storage capacity.

During operation, the vision encoder 180 processes the image frame 112A to generate the encoder output data 128A, as described with reference to FIG. 1A. The vision encoder 180 adds the encoder output data 128A to a memory 132. For example, the vision encoder 180 adds the encoder output data 128A to image analysis data 148 used to represent the sequence of image frames 112 for image-based cognitive analysis. Similarly, the vision encoder 180 processes the image frame 112B to generate the encoder output data 128B, and adds the encoder output data 128B to the image analysis data 148 stored in the memory 132. In a particular aspect, the memory 132 includes a TX buffer and the image analysis data 148 is stored in the TX buffer.

In some aspects, the vision encoder 180 processes all received image frames 112 to generate corresponding sets of encoder output data 128 and stores the sets of encoder output data 128 in the memory 132. In some aspects, the vision encoder 180 selectively processes a received image frame 112 to generate encoder output data 128, selectively stores the encoder output data 128 to the memory 132, or both, as described with reference to FIG. 1A. Optionally, in some examples, the one or more processors 190 include the storage manager 198 of FIG. 1A in addition to the TX manager 288. To illustrate, thresholds used by the TX manager 288 to perform selective transmission can be different from thresholds used by the storage manager 198 to perform selective storage.

The TX manager 288 retrieves the encoder output data 128A from the image analysis data 148 and initiates transmission, at a first time, of the encoder output data 128A corresponding to the image frame 112A. Subsequently, the TX manager 288 retrieves the encoder output data 128B from the image analysis data 148 and selectively initiates transmission of the encoder output data 128B to a device 202.

Optionally, in some embodiments, the TX manager 288 retrieves the image frame 112A and the image frame 112B from the memory 132 and determines whether to initiate transmission of the encoder output data 128B based on a comparison of the image frame 112A and the image frame 112B. To illustrate, the TX manager 288, based on determining that a difference between the image frame 112A and the image frame 112B satisfies (e.g., is greater than) a transmission threshold, transmits the encoder output data 128B to the device 202. Alternatively, the TX manager 288, based on determining that the difference between the image frame 112A and the image frame 112B fails to satisfy (e.g., is less than or equal to) the transmission threshold, refrains from initiating transmission of the encoder output data 128B. For example, the TX manager 288 refrains from transmitting the encoder output data 128B to the device 202, discards the encoder output data 128B, discards the image frame 112B, or a combination thereof.

Optionally, in some embodiments, the TX manager 288 retrieves the encoder output data 128A from the image analysis data 148 stored in the memory 132 and determines whether to transmit the encoder output data 128B based on a comparison of the encoder output data 128A and the encoder output data 128B. To illustrate, the TX manager 288, based on determining that a difference between the encoder output data 128A and the encoder output data 128B satisfies (e.g., is greater than) a transmission threshold, initiates transmission of the encoder output data 128B. Alternatively, the TX manager 288, based on determining that the difference between the encoder output data 128A and the encoder output data 128B fails to satisfy (e.g., is less than or equal to) the transmission threshold, refrains from transmitting the encoder output data 128B. For example, the TX manager 288 refrains from initiating transmission of the encoder output data 128B to the device 202, discards the encoder output data 128B, discards the image frame 112B, or a combination thereof.

Optionally, in some embodiments, the TX manager 288, based on determining that the encoder output data 128A is transmitted at the first time and determining that an elapsed time (e.g., a difference, at a second time, between the first time and the second time) since the first time satisfies (e.g., is greater than) a transmission time threshold, transmits the encoder output data 128B. To illustrate, if the elapsed time since the encoder output data 128A (e.g., most recently transmitted encoder output data) is greater than the transmission time threshold, the encoder output data 128B is transmitted to the device 202 independently of the difference between the image frame 112A and the image frame 112B and the difference between the encoder output data 128A and the encoder output data 128B.

Optionally, in some embodiments, the TX manager 288, based on determining that a count of image frames of the sequence of image frames 112 between the image frame 112A and the image frame 112B satisfies a transmission frame count threshold, transmits the encoder output data 128B to the device 202. To illustrate, if the image frame count since the image frame 112A corresponding to the encoder output data 128A (e.g., most recently transmitted encoder output data) is greater than the transmission frame count threshold, the encoder output data 128B is transmitted independently of the difference between the image frame 112A and the image frame 112B and the difference between the encoder output data 128A and the encoder output data 128B.

Optionally, in some implementations, the TX manager 288, responsive to transmitting the encoder output data 128B, removes the encoder output data 128A, the image frame 112A, or both, from the memory 132. In an example, the TX manager 288 retains the encoder output data 128B, the image frame 112B, or both, corresponding to most recently transmitted encoder output data to perform selective transmission of next encoder output data.

In some aspects, the image-based cognitive analyzer 146 generates, based on the encoder output data 128A, the encoder output data 128B, or both, a response 138 to the query 136, as described with reference to FIG. 1A. In some aspects, the device 202 outputs the response 138 to a display device, a speaker, a network device, the device 102, or a combination thereof.

A technical advantage of the system 200 includes offloading storage of the sets of encoder output data 128 and performance of the image-based cognitive analysis from the device 102 (e.g., XR glasses) to the device 202 (e.g., a companion device). Hence, the device 102 can be a relatively light-weight device, with the device 202 having more resources (e.g., more memory, computing resources, or both).

Another technical advantage of the system 200 includes improved bandwidth without significant adverse impact to performance of the cognitive analysis. For example, the encoder output data 128B is selectively discarded to improve bandwidth if the encoder output data 128B is relatively similar to encoder output data 128A that has recently been transmitted.

In some examples, based on an output of the vision encoder 180, the image-based cognitive analyzer 146, a neural network, a machine-learning model, or a combination thereof, one or more components of a device (e.g., the device 102, the device 202, or both) can perform various operations such as: i) controlling a machine such as a vehicle, a robot, an appliance, a mobile device, a camera; ii) controlling an actuator such as an electromechanical actuator, an electrohydraulic actuator, an electroactive polymer actuator; iii) controlling an active circuit component such as a voltage or current source, a transistor, an amplifier, an integrated circuit, a programmable device such as FPGA, a display device; iii) providing a notification to a user, such as a visual, auditory or haptic notification or combination thereof, iv) launching, closing, pausing or suspending an application on a computer; iv) launching, closing, pausing or suspending playback of audio video (AV) media on a computer; or v) providing a control signal to initiate any of the above.

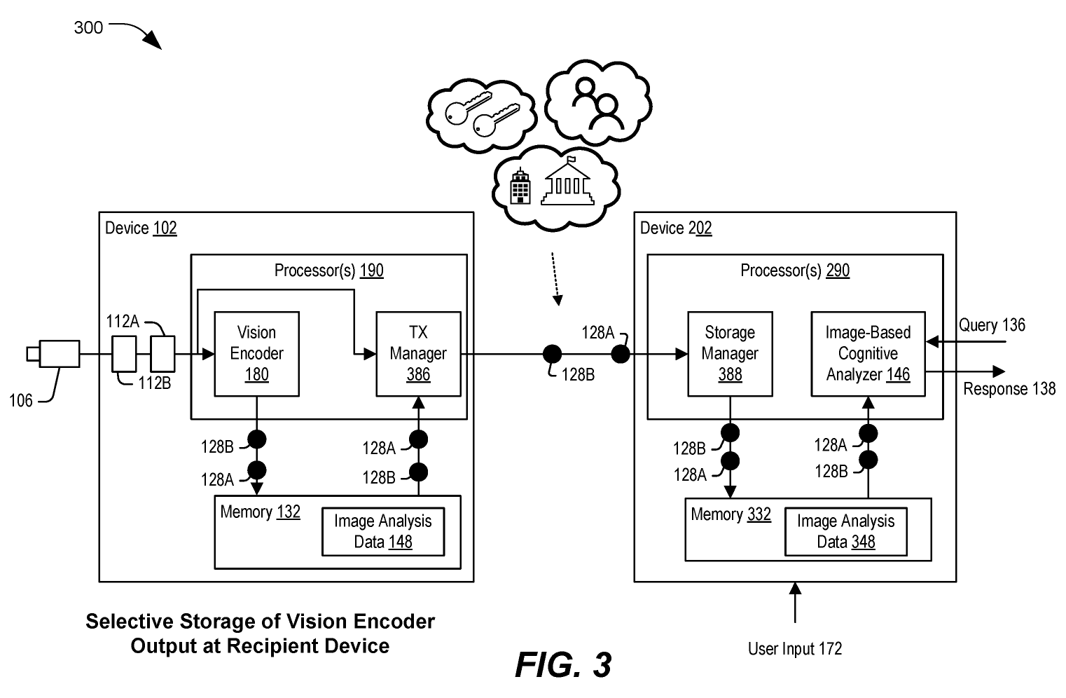

Referring to FIG. 3, a particular illustrative aspect of a system configured to perform selective storage of vision encoder output at a recipient device is disclosed and generally designated 300, in accordance with some examples of the present disclosure.

The one or more processors 190 include the vision encoder 180 and a TX manager 386. The memory 132 is coupled to each of the vision encoder 180 and the TX manager 386. The TX manager 386 is configured to initiate transmission of encoder output data 128.

One or more processors 290 of a device 202 are coupled to a memory 332. The one or more processors 290 include a storage manager 388 and the image-based cognitive analyzer 146. The memory 332 is coupled to each of the storage manager 388 and the image-based cognitive analyzer 146. The memory 332 is configured to store data used or generated by one or more components of the device 202. For example, the memory 332 is configured to store encoder output data 128, image analysis data 348, the query 136, the response 138, or a combination thereof. In a particular aspect, the image analysis data 348 is used to represent the sequence of the image frames 112 for image-based cognitive analysis. In some aspects, the memory 332 includes a data receipt buffer, an image analysis buffer, or both.

The storage manager 388 is configured to receive encoder output data 128 and selectively store the encoder output data 128 in the memory 332. For example, the storage manager 388 is configured to, based on a comparison of encoder output data of image frames, determine whether to add encoder output data to the memory 332. To illustrate, the storage manager 388 is configured to store encoder output data 128A of an image frame 112A in the memory 332. The storage manager 388 is configured to, based on a comparison of the encoder output data 128A and encoder output data 128B of an image frame 112B, determine whether to store the encoder output data 128B in the memory 332. In some aspects, selectively adding the encoder output data 128 to the memory 332 corresponds to selectively adding the encoder output data 128 to image analysis data 348 stored in the memory 332.

The image-based cognitive analyzer 146 is configured to retrieve encoder output data 128 from the image analysis data 348 stored in the memory 332, and use encoder output data 128 to perform image-based cognitive analysis, as described with reference to FIGS. 1A, 1C, and 2.

During operation, the vision encoder 180 processes the image frame 112A to generate the encoder output data 128A, as described with reference to FIG. 1A. The vision encoder 180 adds the encoder output data 128A to a memory 132. For example, the vision encoder 180 adds the encoder output data 128A to image analysis data 148 used to represent the sequence of image frames 112 for image-based cognitive analysis. Similarly, the vision encoder 180 processes the image frame 112B to generate the encoder output data 128B, and adds the encoder output data 128B to the image analysis data 148 stored in the memory 132, as described with reference to FIG. 1A.

In some aspects, the vision encoder 180 processes all received image frames 112 to generate corresponding sets of encoder output data 128 and stores the sets of encoder output data 128 in the memory 132. In some aspects, the vision encoder 180 selectively processes a received image frame 112 to generate encoder output data 128, selectively stores the encoder output data 128 to the memory 132, or both, as described with reference to FIG. 1A. Optionally, in some examples, the one or more processors 190 include the storage manager 198 of FIG. 1A in addition to the TX manager 386.

The TX manager 386 retrieves the encoder output data 128A from the image analysis data 148 and initiates transmission of the encoder output data 128A corresponding to the image frame 112A to a device 202. Subsequently, the TX manager 288 retrieves the encoder output data 128B from the image analysis data 148 and initiates transmission of the encoder output data 128B to the device 202. In a particular aspect, the TX manager 386 includes the TX manager 288 of FIG. 2. For example, the TX manager 386 is configured to selectively transmit encoder output data 128, as described with reference to FIG. 2. In some other aspects, the TX manager 386 is configured to transmit all generated encoder output data 128.

The storage manager 388 receives the encoder output data 128A, and adds the encoder output data 128A to image analysis data 348 stored in the memory 332. The storage manager 388 receives the encoder output data 128B and selectively adds the encoder output data 128B to the image analysis data 148 stored in the memory 132.

Optionally, in some embodiments, the storage manager 388 retrieves the encoder output data 128A from the image analysis data 348 stored in the memory 332 and determines whether to store the encoder output data 128B based on a comparison of the encoder output data 128A and the encoder output data 128B. To illustrate, the storage manager 388, based on determining that a difference between the encoder output data 128A and the encoder output data 128B satisfies (e.g., is greater than) a storage threshold, stores the encoder output data 128B in the memory 332. Alternatively, the storage manager 388, based on determining that the difference between the encoder output data 128A and the encoder output data 128B fails to satisfy (e.g., is less than or equal to) the storage threshold, refrains from storing the encoder output data 128B in the memory 332. For example, the storage manager 388 refrains from adding the encoder output data 128B to the image analysis data 348, discards the encoder output data 128B, or both.

Optionally, in some embodiments, the storage manager 388, based on determining that the encoder output data 128A is added to the memory 332 at a first time and determining that an elapsed time (e.g., a difference, at a second time, between the first time and the second time) since the first time satisfies (e.g., is greater than) a storage time threshold, stores the encoder output data 128B to the image analysis data 348 in the memory 332. To illustrate, if the elapsed time since the encoder output data 128A (e.g., most recently stored encoder output data) is greater than the storage time threshold, the encoder output data 128B is added to the memory 332 independently of the difference between the encoder output data 128A and the encoder output data 128B.

Optionally, in some embodiments, the storage manager 388, based on determining that a count of image frames of the sequence of image frames 112 between the image frame 112A and the image frame 112B satisfies a storage frame count threshold, stores the encoder output data 128B to the image analysis data 348 in the memory 332. To illustrate, if the image frame count since the image frame 112A corresponding to the encoder output data 128A (e.g., most recently stored encoder output data) is greater than the storage frame count threshold, the encoder output data 128B is added to the memory 332 independently of the difference between the encoder output data 128A and the encoder output data 128B.

In some aspects, the image-based cognitive analyzer 146 generates, based on the encoder output data 128A, the encoder output data 128B, or both, a response 138 to the query 136, as described with reference to FIG. 1A. In some aspects, the device 202 outputs the response 138 to a display device, a speaker, a network device, the device 102, or a combination thereof.

A technical advantage of the system 300 includes offloading storage of the sets of encoder output data 128 and performance of the image-based cognitive analysis from the device 102 (e.g., XR glasses) to the device 202 (e.g., a companion device). Hence, the device 102 can be a relatively light-weight device, with the device 202 having more resources (e.g., more memory, computing resources, or both).

Another technical advantage of the system 300 includes reduced memory usage without significant adverse impact to performance of the cognitive analysis. For example, the encoder output data 128B is selectively discarded to reduce memory usage if the encoder output data 128B is relatively similar to encoder output data 128A that has recently been stored.

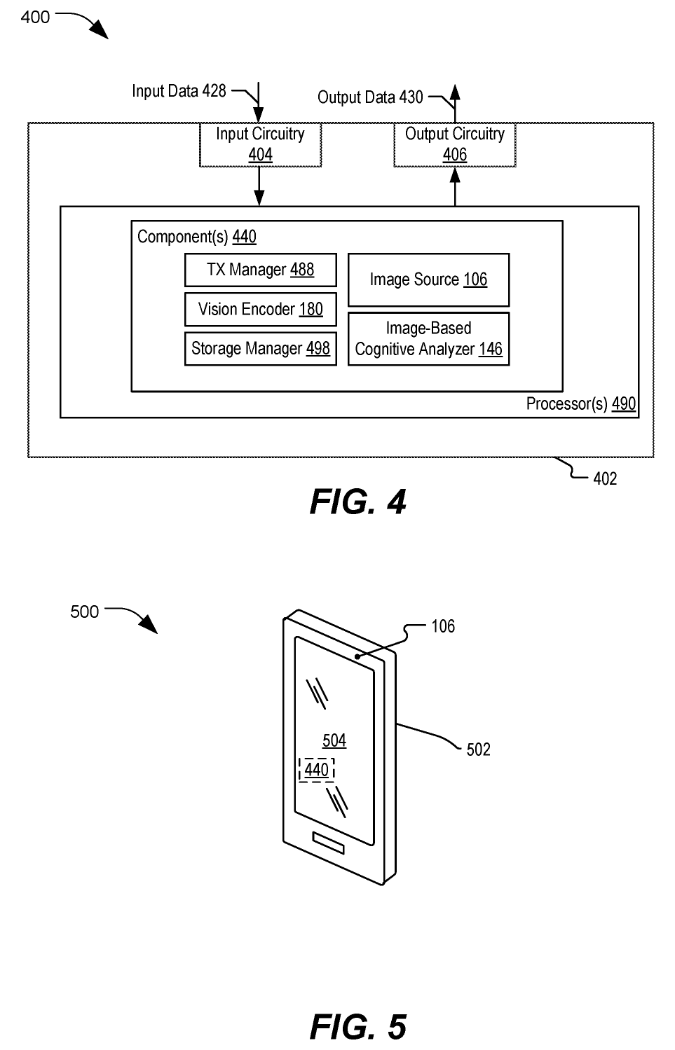

FIG. 4 depicts an implementation 400 of an integrated circuit 402 that includes one or more processors 490. In a particular aspect, the integrated circuit 402 corresponds to an implementation of the device 102, the device 202, or both.

The one or more processors 490 include one or more components 440, such as the image source 106, the vision encoder 180, the image-based cognitive analyzer 146, a storage manager 498, a TX manager 488, or a combination thereof. For example, the vision encoder 180 includes the multi-context local attention(s) 160, the downscaling layer(s) 162, the stage(s) 140, or a combination thereof, as described with reference to FIG. 1B. For example, the image-based cognitive analyzer 146 includes the projector 170, the tokenizer 184, the embedding generator 174, the multimodal transformer network 178, or a combination thereof, as described with reference to FIG. 1C. The storage manager 498 includes the storage manager 198 of FIG. 1A, the storage manager 388 of FIG. 3, or both. The TX manager 488 includes the TX manager 288 of FIG. 2, the TX manager 386 of FIG. 3, or both.

The integrated circuit 402 also includes input circuitry 404, such as one or more bus interfaces, to enable input data 428 to be received for processing. In a particular aspect, the input data 428 includes data used by one or more of the components 440, as described herein. For example, the input data 428 includes the sequence of image frames 112, the encoder output data 128, the image latent data 164, the image latent data 166, the image FEs 154, the query 136, the user input 172, the sets of image tokens 173, the linguistic tokens 186, the input embeddings 176, or a combination thereof.

The integrated circuit 402 also includes output circuitry 406, such as a bus interface, to enable sending of output data 430. In a particular aspect, the output data 430 includes data generated by one or more of the components 440, as described herein. For example, the output data 430 includes the sequence of image frames 112, the encoder output data 128, the image latent data 164, the image latent data 166, the image FEs 154, the sets of encoder output data 128, the response 138, the sets of image tokens 173, the linguistic tokens 186, the input embeddings 176, or a combination thereof.

The integrated circuit 402 enables implementation of selective storage, selective transmission, or both, of encoder output data as a component in a system, such as a mobile phone or tablet as depicted in FIG. 5, a wearable electronic device as depicted in FIG. 6, a mixed reality or augmented reality glasses device, as described with reference to FIG. 7, a voice-controlled speaker system as depicted in FIG. 8, a camera as depicted in FIG. 9, a virtual reality, mixed reality, or augmented reality headset as depicted in FIG. 10, or a vehicle as depicted in FIG. 11 or FIG. 12.

FIG. 5 depicts an implementation 500 of a mobile device 502, such as a phone or tablet, as illustrative, non-limiting examples. In a particular aspect, the mobile device 502 corresponds to an implementation of the device 102, the device 202, or both.

The mobile device 502 includes a display screen 504, and optionally the image source 106. The one or more components 440 of the processor(s) 490 are integrated in the mobile device 502 and are illustrated using dashed lines to indicate internal components that are not generally visible to a user of the mobile device 502. In a particular example, the image-based cognitive analyzer 146 detects the query 136, which is then processed to perform one or more operations at the mobile device 502, such as to launch a graphical user interface or otherwise display the response 138 at the display screen 504 (e.g., via an integrated “smart assistant” application).

The mobile device 502 performs one or more operations described with reference to the device 102, the device 202, or both, of FIGS. 1A-3. For example, in some aspects, the mobile device 502 obtains the image frames 112 from the image source 106 and generates the sets of encoder output data 128, as described with reference to the device 102 of FIG. 1A. In some aspects, the mobile device 502 selectively stores encoder output data 128, as described with reference to FIG. 1A. The mobile device 502, responsive to receiving the query 136, uses the image-based cognitive analyzer 146 to generate the response 138 and outputs the response 138, as described with reference to the device 102 of FIG. 1A.

In some aspects, the mobile device 502 obtains the image frames 112 from the image source 106, generates the sets of encoder output data 128, and sends the sets of encoder output data 128 to another device, as described with reference to the device 102 of FIGS. 2-3. In some examples, the mobile device 502 selectively transmits encoder output data 128, as described with reference to FIG. 2. In some examples, the mobile device 502 receives the query 136 and provides the query 136 to the other device. The other device uses the image-based cognitive analyzer 146 to generate the response 138, as described with reference to the device 202 of FIGS. 2-3. The mobile device 502 receives the response 138 from the other device and outputs the response 138. In some examples, the other device receives the query 136, uses the image-based cognitive analyzer 146 to generate the response 138, and outputs the response 138, as described with reference to the device 202 of FIGS. 2-3.

In some aspects, the mobile device 502 obtains the sets of encoder output data 128 from a second device (e.g., XR glasses), uses the image-based cognitive analyzer 146 to perform the cognitive analysis to generate the response 138, and outputs the response 138, as described with reference to the device 202 of FIGS. 2-3. In some examples, the mobile device 502 selectively stores received encoder output data 128, as described with reference to FIG. 3.

FIG. 6 depicts an implementation 600 of a wearable electronic device 602, illustrated as a “smart watch.” In a particular aspect, the wearable electronic device 602 corresponds to an implementation of the device 102, the device 202, or both.

The one or more components 440, and optionally the image source 106, are integrated into the wearable electronic device 602. The wearable electronic device 602 performs one or more operations described with reference to the device 102, the device 202, or both, of FIGS. 1A-3. For example, the component(s) 440 operate to obtain the image frames 112, the sets of encoder output data 128, the query 136, the response 138, or a combination thereof, which are then processed to perform one or more operations at the wearable electronic device 602, such as to launch a graphical user interface or otherwise display other information associated with the image frames 112, the sets of encoder output data 128, the query 136, the response 138, or a combination thereof at a display screen 604 of the wearable electronic device 602.

In some aspects, the wearable electronic device 602 may include a display screen that is configured to display a notification based on obtaining the image frames 112, the sets of encoder output data 128, the query 136, the response 138, or a combination thereof. In a particular example, the wearable electronic device 602 includes a haptic device that provides a haptic notification (e.g., vibrates) in response to obtaining the image frames 112, the sets of encoder output data 128, the query 136, the response 138, or a combination thereof. For example, the haptic notification can cause a user to look at the wearable electronic device 602 to see a displayed notification indicating detection of the image frames 112, the sets of encoder output data 128, the query 136, the response 138, or a combination thereof. The wearable electronic device 602 can thus alert a user with a hearing impairment or a user wearing a headset that the image frames 112, the sets of encoder output data 128, the query 136, the response 138, or a combination thereof, are detected. In some examples, the wearable electronic device 602 selectively stores generated encoder output data 128, as described with reference to FIG. 1A, selectively transmits encoder output data 128, as described with reference to FIG. 2, selectively stores received encoder output data 128, as described with reference to FIG. 3, or a combination thereof.

FIG. 7 depicts an implementation 700 of a portable electronic device that corresponds to augmented reality or mixed reality glasses 702. In a particular aspect, the glasses 702 correspond to an implementation of the device 102, the device 202, or both.

The glasses 702 include a holographic projection unit 704 configured to project visual data onto a surface of a lens 706 or to reflect the visual data off of a surface of the lens 706 and onto the wearer’s retina. The one or more components 440 and, optionally the image source 106, are integrated into the glasses 702. The glasses 702 perform one or more operations described with reference to the device 102, the device 202, or both, of FIGS. 1A-3. For example, the component(s) 440 may function to obtain the image frames 112, the sets of encoder output data 128, the query 136, the response 138, or a combination thereof, as described with reference to FIGS. 1A-3.

In a particular example, the holographic projection unit 704 is configured to display a notification based on obtaining the image frames 112, the sets of encoder output data 128, the query 136, the response 138, or a combination thereof. For example, the notification can be superimposed on the user’s field of view at a particular position that coincides with a location related to an answer indicated in the response 138. In some examples, the glasses 702 selectively store generated encoder output data 128, as described with reference to FIG. 1A, selectively transmit encoder output data 128, as described with reference to FIG. 2, selectively store received encoder output data 128, as described with reference to FIG. 3, or a combination thereof.

FIG. 8 is an implementation 800 of a wireless speaker and voice activated device 802. In a particular aspect, the wireless speaker and voice activated device 802 corresponds to an implementation of the device 102, the device 202, or both.

The wireless speaker and voice activated device 802 can have wireless network connectivity and is configured to execute an assistant operation. The one or more components 440 and, optionally the image source 106, are integrated into the wireless speaker and voice activated device 802. The wireless speaker and voice activated device 802 also includes a speaker 804.

The wireless speaker and voice activated device 802 performs one or more operations described with reference to the device 102, the device 202, or both, of FIGS. 1A-3. For example, the component(s) 440 may function to obtain the image frames 112, the sets of encoder output data 128, the query 136, the response 138, or a combination thereof, as described with reference to FIGS. 1A-3.

During operation, in response to receiving a verbal command, the wireless speaker and voice activated device 802 can execute assistant operations, such as via execution of a voice activation system (e.g., an integrated assistant application). The assistant operations can include adjusting a temperature, playing music, turning on lights, etc. For example, the assistant operations are performed responsive to receiving a command after a keyword or key phrase (e.g., “hello assistant”). In an example, the assistant operations include generating the response 138 to the query 136, as described with reference to the device 102, the device 202, or both, of FIGS. 1A-3. In some examples, the wireless speaker and voice activated device 802 selectively stores generated encoder output data 128, as described with reference to FIG. 1A, selectively transmits encoder output data 128, as described with reference to FIG. 2, selectively stores received encoder output data 128, as described with reference to FIG. 3, or a combination thereof.

FIG. 9 depicts an implementation 900 of a portable electronic device that corresponds to a camera device 902. In a particular aspect, the camera device 902 corresponds to an implementation of the device 102, the device 202, or both.

The one or more components 440 and, optionally the image source 106, are included in the camera device 902. The camera device 902 performs one or more operations described with reference to the device 102, the device 202, or both, of FIGS. 1A-3. For example, the component(s) 440 may function to obtain the image frames 112, the sets of encoder output data 128, the query 136, the response 138, or a combination thereof, as described with reference to FIGS. 1A-3.

During operation, in response to receiving a verbal command, the camera device 902 can execute operations responsive to spoken user commands, such as to adjust image or video capture settings, image or video playback settings, or image or video capture instructions, as illustrative examples. In an example, the camera device 902 generates the response 138 to the query 136, as described with reference to the device 102, the device 202, or both, of FIGS. 1A-3. In some examples, the camera device 902 selectively stores generated encoder output data 128, as described with reference to FIG. 1A, selectively transmits encoder output data 128, as described with reference to FIG. 2, selectively stores received encoder output data 128, as described with reference to FIG. 3, or a combination thereof.

FIG. 10 depicts an implementation 1000 of a portable electronic device that corresponds to a virtual reality, mixed reality, or augmented reality headset 1002. In a particular aspect, the headset 1002 corresponds to an implementation of the device 102, the device 202, or both.

The one or more components 440 and, optionally the image source 106, are included in the headset 1002. The headset 1002 performs one or more operations described with reference to the device 102, the device 202, or both, of FIGS. 1A-3. For example, the component(s) 440 may function to obtain the image frames 112, the sets of encoder output data 128, the query 136, the response 138, or a combination thereof, as described with reference to FIGS. 1A-3.

In some aspects, the headset 1002 obtains the sequence of image frames 112 from the image source 106, generates the sets of encoder output data 128, and sends the sets of encoder output data 128 to another device (e.g., the mobile device 502 of FIG. 10), as described with reference to the device 102 of FIGS. 2-3. The other device uses the image-based cognitive analyzer 146 to generate the response 138, as described with reference to the device 202 of FIGS. 2-3. The headset 1002, the other device, or both, output the response 138.

In some examples, the headset 1002 selectively stores generated encoder output data 128, as described with reference to FIG. 1A, selectively transmits encoder output data 128, as described with reference to FIG. 2, selectively stores received encoder output data 128, as described with reference to FIG. 3, or a combination thereof.

In an example, a visual interface device is positioned in front of the user's eyes to enable display of augmented reality, mixed reality, or virtual reality images or scenes to the user while the headset 1002 is worn. In a particular example, the visual interface device is configured to display a notification indicating that image frames 112, the sets of encoder output data 128, the query 136, the response 138, or a combination thereof, are detected. In some examples, the visual interface is configured to display the response 138.

FIG. 11 depicts an implementation 1100 of a vehicle 1102, illustrated as a manned or unmanned aerial device (e.g., a package delivery drone). In a particular aspect, the device 102, the device 202, or both, correspond to or are integrated into the vehicle 1102.

The one or more components 440 and, optionally the image source 106, are included in the vehicle 1102. The vehicle 1102 performs one or more operations described with reference to the device 102, the device 202, or both, of FIGS. 1A-3. For example, the component(s) 440 may function to obtain the image frames 112, the sets of encoder output data 128, the query 136, the response 138, or a combination thereof, as described with reference to FIGS. 1A-3.

In an example, the vehicle 1102 receives a query 136, such as for installation instructions, of a delivered package depicted in the sequence of image frames 112. The vehicle 1102 processes the image frames 112 to generate the sets of encoder output data 128. In some examples, the vehicle 1102 uses the image-based cognitive analyzer 146 to process the sets of encoder output data 128 to generate the response 138 to the query 136, as described with reference to the device 102 of FIG. 1A. In some examples, the vehicle 1102 sends the sets of encoder output data 128 to another device, as described with reference to the device 102 of FIGS. 2-3. The other device uses the image-based cognitive analyzer 146 to process the sets of encoder output data 128 to generate the response 138, as described with reference to the device 202 of FIGS. 2-3. In a particular aspect, the vehicle 1102 outputs the response 138.

In some examples, the vehicle 1102 selectively stores generated encoder output data 128, as described with reference to FIG. 1A, selectively transmits encoder output data 128, as described with reference to FIG. 2, selectively stores received encoder output data 128, as described with reference to FIG. 3, or a combination thereof.

FIG. 12 depicts another implementation 1200 of a vehicle 1202, illustrated as a car. In a particular aspect, the vehicle 1202 corresponds to an implementation of the device 102, the device 202, or both. In a particular aspect, the device 102, the device 202, or both, correspond to or are integrated into the vehicle 1202.

The one or more components 440 and, optionally the image source 106, are included in the vehicle 1202. In some aspects, the vehicle 1202 includes a microphone 1222. The vehicle 1202 performs one or more operations described with reference to the device 102, the device 202, or both, of FIGS. 1A-3. For example, the component(s) 440 may function to obtain the image frames 112, the sets of encoder output data 128, the query 136, the response 138, or a combination thereof, as described with reference to FIGS. 1A-3.

In some aspects, the query 136 may be detected based on audio signals received from the microphone 1222 of the vehicle 1202. In some implementations, query detection can be performed based on an audio signal received from interior microphones (e.g., the microphone 1222), such as for a voice query from an authorized passenger. In some implementations, query detection can be performed based on an audio signal received from external microphones (e.g., the microphone 1222), such as an authorized user of the vehicle. In a particular implementation, in response to receiving a verbal command, a voice activation system initiates one or more operations of the vehicle 1202 based on one or more keywords (e.g., “unlock,” “start engine,” “play music,” “display weather forecast,” or another voice command) detected in an audio signal, such as by providing feedback or information via a display 1220 or one or more speakers (e.g., a speaker 1210).

In some aspects, the vehicle 1202 processes image frames 112 to generate the sets of encoder output data 128. In some examples, the vehicle 1202 uses the image-based cognitive analyzer 146 to process the sets of encoder output data 128 to generate the response 138 to the query 136, as described with reference to the device 102 of FIG. 1A. In some examples, the vehicle 1202 sends the sets of encoder output data 128 to another device, as described with reference to the device 102 of FIGS. 2-3. The other device uses the image-based cognitive analyzer 146 to process the sets of encoder output data 128 to generate the response 138, as described with reference to the device 202 of FIGS. 2-3. In a particular aspect, the vehicle 1202 outputs the response 138 via the display 1220, the speaker 1210, or both. In some examples, the vehicle 1202 selectively stores generated encoder output data 128, as described with reference to FIG. 1A, selectively transmits encoder output data 128, as described with reference to FIG. 2, selectively stores received encoder output data 128, as described with reference to FIG. 3, or a combination thereof.

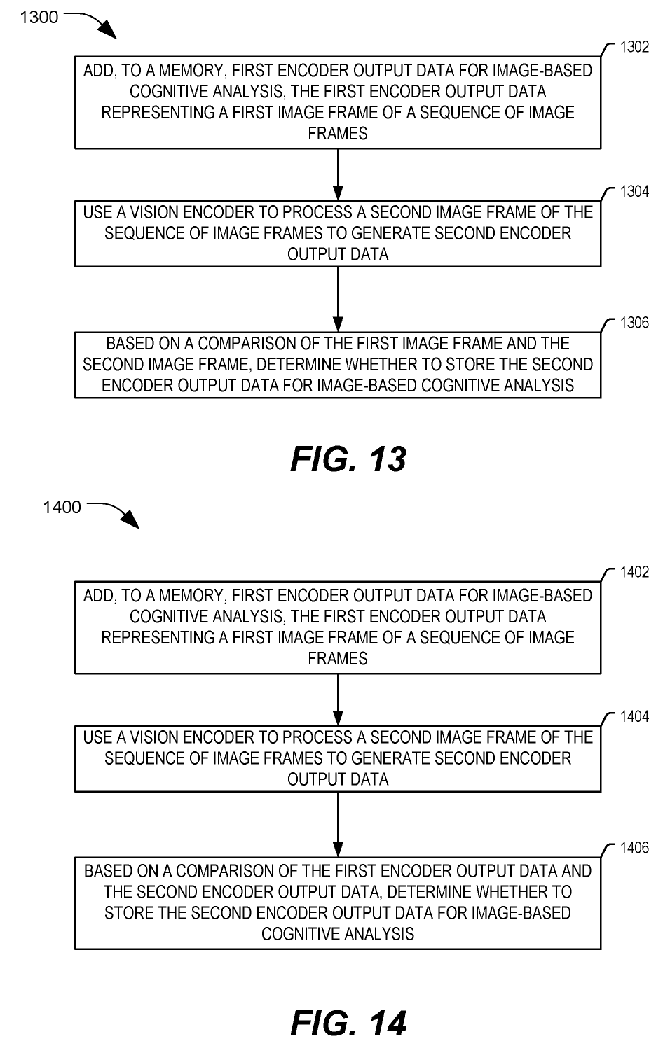

Referring to FIG. 13, a particular implementation of a method 1300 of performing selective storage of vision encoder output is shown. In a particular aspect, one or more operations of the method 1300 are performed by at least one of the storage manager 198, the one or more processors 190, the device 102, the system 100 of FIG. 1A, the system 200 of FIG. 2, the system 300 of FIG. 3, the one or more components 440, the integrated circuit 402 of FIG. 4, or a combination thereof.

The method 1300 includes, at 1302, adding, to a memory, first encoder output data for image-based cognitive analysis, the first encoder output data representing a first image frame of a sequence of image frames. For example, the storage manager 198 of FIG. 1A adds the encoder output data 128A to the memory 132 for image-based cognitive analysis, as described with reference to FIG. 1A. The encoder output data 128A represents the image frame 112A of the sequence of image frames 112.

The method 1300 also includes, at 1304, using a vision encoder to process a second image frame of the sequence of image frames to generate second encoder output data. For example, the vision encoder 180 processes the image frame 112B of the sequence of image frames 112 to generate encoder output data 128B, as described with reference to FIG. 1A.

The method 1300 further includes, at 1306, based on a comparison of the first image frame and the second image frame, determining whether to store the second encoder output data for image-based cognitive analysis. For example, the storage manager 198 of FIG. 1A, based on a comparison of the image frame 112A and the image frame 112B, determines whether to store the encoder output data 128B for the image-based cognitive analysis, as described with reference to FIG. 1A.

A technical advantage of the method 1300 includes reduced memory usage without significant adverse impact to performance of the cognitive analysis. For example, the encoder output data 128B is selectively discarded to reduce memory usage if the image frame 112B is relatively similar to image frame 112A corresponding to the encoder output data 128A that has recently been stored.

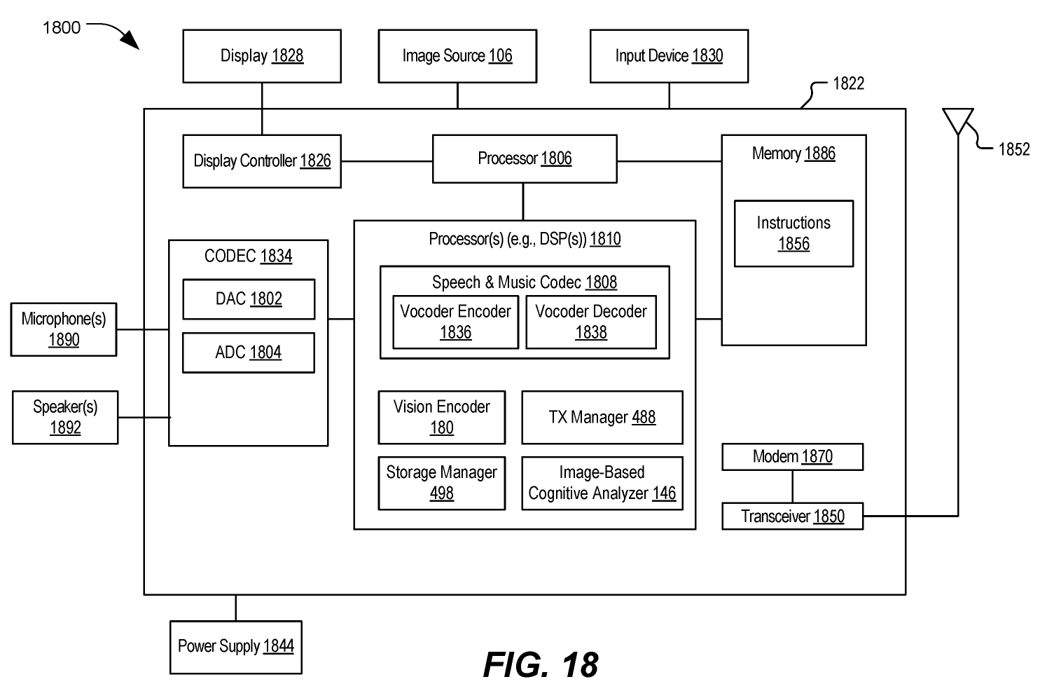

The method 1300 of FIG. 13 may be implemented by a FPGA device, an application-specific integrated circuit (ASIC), a processing unit such as a central processing unit (CPU), a digital signal processor (DSP), a controller, another hardware device, firmware device, or any combination thereof. As an example, the method 1300 of FIG. 13 may be performed by a processor that executes instructions, such as described with reference to FIG. 18.

Referring to FIG. 14, a particular implementation of a method 1400 of performing selective storage of vision encoder output is shown. In a particular aspect, one or more operations of the method 1400 are performed by at least one of the storage manager 198, the one or more processors 190, the device 102, the system 100 of FIG. 1A, the system 200 of FIG. 2, the system 300 of FIG. 3, the one or more components 440, the integrated circuit 402 of FIG. 4, or a combination thereof.

The method 1400 includes, at 1402, adding, to a memory, first encoder output data for image-based cognitive analysis, the first encoder output data representing a first image frame of a sequence of image frames. For example, the storage manager 198 of FIG. 1A adds the encoder output data 128A to the memory 132 for image-based cognitive analysis, as described with reference to FIG. 1A. The encoder output data 128A represents the image frame 112A of the sequence of image frames 112.

The method 1400 also includes, at 1404, using a vision encoder to process a second image frame of the sequence of image frames to generate second encoder output data. For example, the vision encoder 180 processes the image frame 112B of the sequence of image frames 112 to generate encoder output data 128B, as described with reference to FIG. 1A.

The method 1400 further includes, at 1406, based on a comparison of the first encoder output data and the second encoder output data, determining whether to store the second encoder output data for image-based cognitive analysis. For example, the storage manager 198 of FIG. 1A, based on a comparison of the encoder output data 128A and the encoder output data 128B, determines whether to store the encoder output data 128B for the image-based cognitive analysis, as described with reference to FIG. 1A.

A technical advantage of the method 1400 includes reduced memory usage without significant adverse impact to performance of the cognitive analysis. For example, the encoder output data 128B is selectively discarded to reduce memory usage if the encoder output data 128B is relatively similar to encoder output data 128A that has recently been stored.

The method 1400 of FIG. 14 may be implemented by a FPGA device, an ASIC, a processing unit such as a CPU, a DSP, a controller, another hardware device, firmware device, or any combination thereof. As an example, the method 1400 of FIG. 14 may be performed by a processor that executes instructions, such as described with reference to FIG. 18.

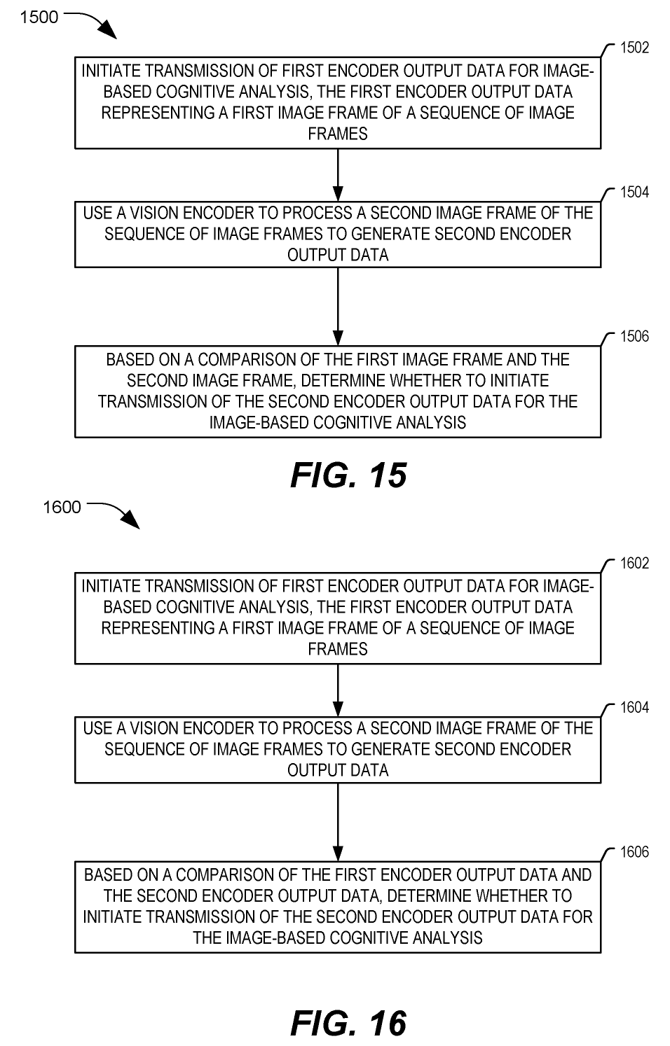

Referring to FIG. 15, a particular implementation of a method 1500 of performing selective transmission of vision encoder output is shown. In a particular aspect, one or more operations of the method 1500 are performed by at least one of the one or more processors 190, the device 102, the system 100 of FIG. 1A, the TX manager 288, the system 200 of FIG. 2, the system 300 of FIG. 3, the one or more components 440, the integrated circuit 402 of FIG. 4, or a combination thereof.

The method 1500 includes, at 1502, initiating transmission of first encoder output data for image-based cognitive analysis, the first encoder output data representing a first image frame of a sequence of image frames. For example, the TX manager 288 initiates transmission of the encoder output data 128A for image-based cognitive analysis. The encoder output data 128A corresponds to the image frame 112A of the sequence of image frames 112, as described with reference to FIG. 2.

The method 1500 includes, at 1504, using a vision encoder to process a second image frame of the sequence of image frames to generate second encoder output data. For example, the vision encoder 180 processes the image frame 112B to generate the encoder output data 128B, as described with reference to FIG. 2.

The method 1500 includes, at 1506, based on a comparison of the first image frame and the second image frame, determining whether to initiate transmission of the second encoder output data for the image-based cognitive analysis. For example, the TX manager 288, based on a comparison of the image frame 112A and the image frame 112B, determines whether to initiate transmission of the encoder output data 128B, as described with reference to FIG. 2.

A technical advantage of the method 1500 includes improved bandwidth without significant adverse impact to performance of the cognitive analysis. For example, the encoder output data 128B is selectively discarded to improve bandwidth if the image frame 112B is relatively similar to image frame 112A corresponding to the encoder output data 128A that has recently been transmitted.

The method 1500 of FIG. 15 may be implemented by a FPGA device, an ASIC, a processing unit such as a CPU, a DSP, a controller, another hardware device, firmware device, or any combination thereof. As an example, the method 1500 of FIG. 15 may be performed by a processor that executes instructions, such as described with reference to FIG. 18.

Referring to FIG. 16, a particular implementation of a method 1600 of performing selective transmission of vision encoder output is shown. In a particular aspect, one or more operations of the method 1600 are performed by at least one of the one or more processors 190, the device 102, the system 100 of FIG. 1A, the TX manager 288, the system 200 of FIG. 2, the system 300 of FIG. 3, the one or more components 440, the integrated circuit 402 of FIG. 4, or a combination thereof.

The method 1600 includes, at 1602, initiating transmission of first encoder output data for image-based cognitive analysis, the first encoder output data representing a first image frame of a sequence of image frames. For example, the TX manager 288 initiates transmission of the encoder output data 128A for image-based cognitive analysis. The encoder output data 128A corresponds to the image frame 112A of the sequence of image frames 112, as described with reference to FIG. 2.

The method 1600 includes, at 1604, using a vision encoder to process a second image frame of the sequence of image frames to generate second encoder output data. For example, the vision encoder 180 processes the image frame 112B to generate the encoder output data 128B, as described with reference to FIG. 2.

The method 1600 includes, at 1606, based on a comparison of the first encoder output data and the second encoder output data, determining whether to initiate transmission of the second encoder output data for the image-based cognitive analysis. For example, the TX manager 288, based on a comparison of the encoder output data 128A and the encoder output data 128B, determines whether to initiate transmission of the encoder output data 128B, as described with reference to FIG. 2.

A technical advantage of the method 1600 includes improved bandwidth without significant adverse impact to performance of the cognitive analysis. For example, the encoder output data 128B is selectively discarded to improve bandwidth if the encoder output data 128B is relatively similar to encoder output data 128A that has recently been transmitted.

The method 1600 of FIG. 16 may be implemented by a FPGA device, an ASIC, a processing unit such as a CPU, a DSP, a controller, another hardware device, firmware device, or any combination thereof. As an example, the method 1600 of FIG. 16 may be performed by a processor that executes instructions, such as described with reference to FIG. 18.

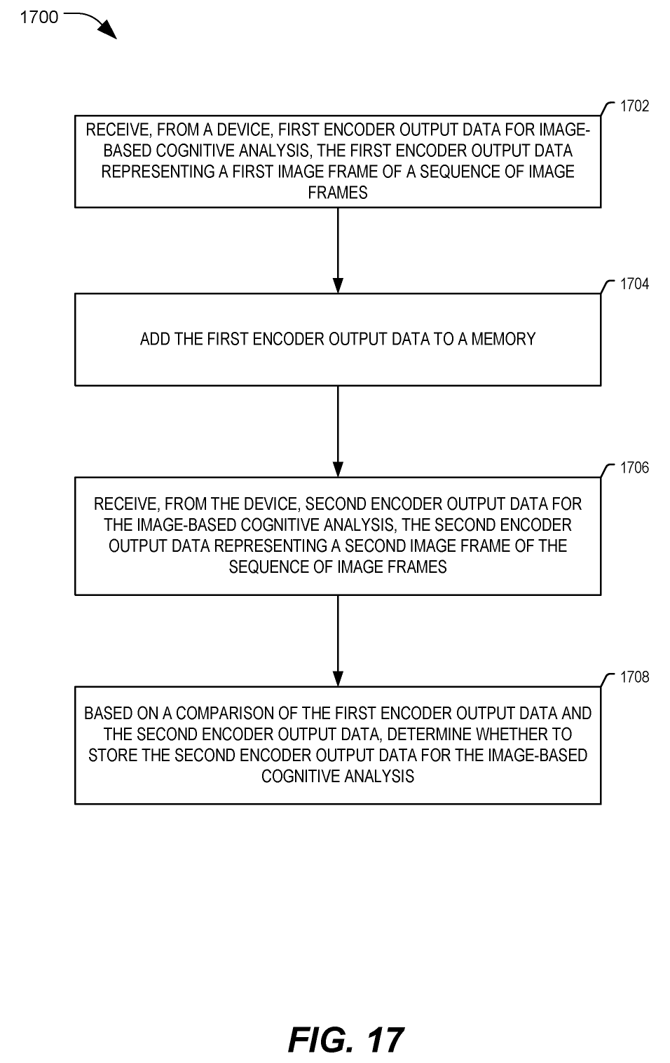

Referring to FIG. 17, a particular implementation of a method 1700 of performing selective storage of vision encoder output at a recipient device is shown. In a particular aspect, one or more operations of the method 1700 are performed by at least one of the one or more processors 190, the device 102, the system 100 of FIG. 1A, the system 200 of FIG. 2, the storage manager 388, the system 300 of FIG. 3, the one or more components 440, the integrated circuit 402 of FIG. 4, or a combination thereof.

The method 1700 includes, at 1702, receiving, from a device, first encoder output data for image-based cognitive analysis, the first encoder output data representing a first image frame of a sequence of image frames. For example, the storage manager 388 of FIG. 3 receives, from the device 102, the encoder output data 128A for image-based cognitive analysis, as described with reference to FIG. 3. The encoder output data 128A corresponds to the image frame 112A of the sequence of image frames 112.

The method 1700 includes, at 1704, adding the first encoder output data to a memory. For example, the storage manager 388 of FIG. 3 adds the encoder output data 128A to the memory 332, as described with reference to FIG. 3.

The method 1700 includes, at 1706, receiving, from the device, second encoder output data for the image-based cognitive analysis, the second encoder output data representing a second image frame of the sequence of image frames. For example, the storage manager 388 of FIG. 3 receives, from the device 102, the encoder output data 128B for image-based cognitive analysis, as described with reference to FIG. 3. The encoder output data 128B corresponds to the image frame 112B of the sequence of image frames 112.

The method 1700 includes, at 1708, based on a comparison of the first encoder output data and the second encoder output data, determining whether to store the second encoder output data for the image-based cognitive analysis. For example, the storage manager 388 of FIG. 3, based on a comparison of the encoder output data 128A and the encoder output data 128B, determines whether to store the encoder output data 128B, as described with reference to FIG. 3.

A technical advantage of the method 1700 includes reduced memory usage without significant adverse impact to performance of the cognitive analysis. For example, the encoder output data 128B is selectively discarded to reduce memory usage if the encoder output data 128B is relatively similar to encoder output data 128A that has recently been stored.

The method 1700 of FIG. 17 may be implemented by a FPGA device, an ASIC, a processing unit such as a CPU, a DSP, a controller, another hardware device, firmware device, or any combination thereof. As an example, the method 1700 of FIG. 17 may be performed by a processor that executes instructions, such as described with reference to FIG. 18.

Referring to FIG. 18, a block diagram of a particular illustrative implementation of a device is depicted and generally designated 1800. In various implementations, the device 1800 may have more or fewer components than illustrated in FIG. 18. In an illustrative implementation, the device 1800 may correspond to the device 102, the device 202, or both. In an illustrative implementation, the device 1800 may perform one or more operations described with reference to FIGS. 1A-17.

In a particular implementation, the device 1800 includes a processor 1806 (e.g., a CPU). The device 1800 may include one or more additional processors 1810 (e.g., one or more DSPs). In a particular aspect, the one or more processors 190 of FIG. 1A, the one or more processors 290 of FIG. 2, the one or more processor(s) 490 of FIG. 4, or a combination thereof, correspond to the processor 1806, the processors 1810, or a combination thereof. The processors 1810 may include a speech and music coder-decoder (CODEC) 1808 that includes a voice coder (“vocoder”) encoder 1836, a vocoder decoder 1838, or both. The processors 1810 include the vision encoder 180, the image-based cognitive analyzer 146, the TX manager 488, the storage manager 498, or a combination thereof. Optionally, in some embodiments, the processors 1810 include the image source 106.

The device 1800 may include a memory 1886 and a CODEC 1834. The memory 1886 may include instructions 1856, that are executable by the one or more additional processors 1810 (or the processor 1806) to implement the functionality described with reference to the one or more components 440. The one or more components 440 include the image-based cognitive analyzer 146, the vision encoder 180, the TX manager 488, the storage manager 498, the image source 106, or a combination thereof, as described with reference to FIG. 4. The device 1800 may include a modem 1870 coupled, via a transceiver 1850, to an antenna 1852.

In a particular aspect, the modem 1870 is configured to transmit one or more sets of encoder output data 128, receive one or more sets of encoder output data 128, or both. For example, the modem 1870 may transmit one or more first sets of encoder output data 128 to one device and receive one or more second sets of encoder output data 128 from another device. Optionally, in some embodiments, the modem 1870 is configured to receive the sequence of image frames 112 from the image source 106.

The device 1800 may include a display 1828 coupled to a display controller 1826. One or more speakers 1892, one or more microphones 1890, or a combination thereof may be coupled to the CODEC 1834. The CODEC 1834 may include a digital-to-analog converter (DAC) 1802, an analog-to-digital converter (ADC) 1804, or both. In a particular implementation, the CODEC 1834 may receive analog signals from the one or more microphones 1890, convert the analog signals to digital signals using the analog-to-digital converter 1804, and provide the digital signals to the speech and music codec 1808. The speech and music codec 1808 may process the digital signals. In a particular implementation, the speech and music codec 1808 may provide digital signals to the CODEC 1834. The CODEC 1834 may convert the digital signals to analog signals using the digital-to-analog converter 1802 and may provide the analog signals to the one or more speakers 1892.

In a particular implementation, the device 1800 may be included in a system-in-package or system-on-chip device 1822. In a particular implementation, the memory 1886, the processor 1806, the processors 1810, the display controller 1826, the CODEC 1834, and the modem 1870 are included in the system-in-package or system-on-chip device 1822. In a particular implementation, an input device 1830, a power supply 1844, and optionally the image source 106, are coupled to the system-in-package or the system-on-chip device 1822. Moreover, in a particular implementation, as illustrated in FIG. 18, the display 1828, the input device 1830, the one or more speakers 1892, the one or more microphones 1890, the antenna 1852, the power supply 1844, and optionally the image source 106, are external to the system-in-package or the system-on-chip device 1822. In a particular implementation, each of the display 1828, the input device 1830, the one or more speakers 1892, the one or more microphones 1890, the antenna 1852, the power supply 1844, and optionally the image source 106 may be coupled to a component of the system-in-package or the system-on-chip device 1822, such as an interface or a controller.

The device 1800 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an extended reality headset, an aerial vehicle, a home automation system, a voice-activated device, a wireless speaker and voice activated device, a portable electronic device, a car, a computing device, a communication device, an internet-of-things (IoT) device, a virtual reality (VR) device, an extended reality (XR) device, a base station, a mobile device, or any combination thereof.

In conjunction with the described implementations, an apparatus includes means for adding, to a memory, first encoder output data for image-based cognitive analysis, the first encoder output data representing a first image frame of a sequence of image frames. For example, the means for adding can correspond to the storage manager 198, the one or more processors 190, the device 102, the system 100 of FIG. 1A, the system 200 of FIG. 2, the system 300 of FIG. 3, the one or more processors 490, the integrated circuit 402 of FIG. 4, the processor 1806, the processor 1810, the device 1800, one or more other circuits or components configured to add first encoder output data to a memory, or any combination thereof.

The apparatus also includes means for using a vision encoder to process a second image frame of the sequence of image frames to generate second encoder output data. For example, the means for using a vision encoder can correspond to the vision encoder 180, the one or more processors 190, the device 102, the system 100 of FIG. 1A, the system 200 of FIG. 2, the system 300 of FIG. 3, the one or more processors 490, the integrated circuit 402 of FIG. 4, the processor 1806, the processor 1810, the device 1800, one or more other circuits or components configured to use a vision encoder, or any combination thereof.

The apparatus also includes means for determining, based on a comparison of the first image frame and the second image frame, whether to store the second encoder output data for image-based cognitive analysis. For example, the means for determining can correspond to the storage manager 198, the one or more processors 190, the device 102, the system 100 of FIG. 1A, the system 200 of FIG. 2, the system 300 of FIG. 3, the one or more processors 490, the integrated circuit 402 of FIG. 4, the processor 1806, the processor 1810, the device 1800, one or more other circuits or components configured to determine whether to store the second encoder output data, or any combination thereof.

Also in conjunction with the described implementations, an apparatus includes means for adding, to a memory, first encoder output data for image-based cognitive analysis, the first encoder output data representing a first image frame of a sequence of image frames. For example, the means for adding can correspond to the storage manager 198, the one or more processors 190, the device 102, the system 100 of FIG. 1A, the system 200 of FIG. 2, the system 300 of FIG. 3, the one or more processors 490, the integrated circuit 402 of FIG. 4, the processor 1806, the processor 1810, the device 1800, one or more other circuits or components configured to add first encoder output data to a memory, or any combination thereof.

The apparatus also includes means for using a vision encoder to process a second image frame of the sequence of image frames to generate second encoder output data. For example, the means for using a vision encoder can correspond to the vision encoder 180, the one or more processors 190, the device 102, the system 100 of FIG. 1A, the system 200 of FIG. 2, the system 300 of FIG. 3, the one or more processors 490, the integrated circuit 402 of FIG. 4, the processor 1806, the processor 1810, the device 1800, one or more other circuits or components configured to use a vision encoder, or any combination thereof.

The apparatus also includes means for determining, based on a comparison of the first encoder output data and the second encoder output data, whether to store the second encoder output data for image-based cognitive analysis. For example, the means for determining can correspond to the storage manager 198, the one or more processors 190, the device 102, the system 100 of FIG. 1A, the system 200 of FIG. 2, the system 300 of FIG. 3, the one or more processors 490, the integrated circuit 402 of FIG. 4, the processor 1806, the processor 1810, the device 1800, one or more other circuits or components configured to determine whether to store the second encoder output data, or any combination thereof.

Also in conjunction with the described implementations, an apparatus includes means for initiating transmission of first encoder output data for image-based cognitive analysis, the first encoder output data representing a first image frame of a sequence of image frames. For example, the means for initiating transmission can correspond to the one or more processors 190, the device 102, the system 100 of FIG. 1A, the TX manager 288, the system 200 of FIG. 2, the system 300 of FIG. 3, the one or more processors 490, the integrated circuit 402 of FIG. 4, the processor 1806, the processor 1810, the antenna 1852, the transceiver 1850, the modem 1870, the device 1800, one or more other circuits or components configured to initiate transmission of first encoder output data, or any combination thereof.

The apparatus also includes means for using a vision encoder to process a second image frame of the sequence of image frames to generate second encoder output data. For example, the means for using a vision encoder can correspond to the vision encoder 180, the one or more processors 190, the device 102, the system 100 of FIG. 1A, the system 200 of FIG. 2, the system 300 of FIG. 3, the one or more processors 490, the integrated circuit 402 of FIG. 4, the processor 1806, the processor 1810, the device 1800, one or more other circuits or components configured to use a vision encoder, or any combination thereof.

The apparatus also includes means for determining, based on a comparison of the first image frame and the second image frame, whether to initiate transmission of the second encoder output data for the image-based cognitive analysis. For example, the means for determining can correspond to the one or more processors 190, the device 102, the system 100 of FIG. 1A, the TX manager 288, the system 200 of FIG. 2, the system 300 of FIG. 3, the one or more processors 490, the integrated circuit 402 of FIG. 4, the processor 1806, the processor 1810, the device 1800, one or more other circuits or components configured to determine whether to initiate transmission of second encoder output data, or any combination thereof.

Also in conjunction with the described implementations, an apparatus includes means for initiating transmission of first encoder output data for image-based cognitive analysis, the first encoder output data representing a first image frame of a sequence of image frames. For example, the means for initiating transmission can correspond to the one or more processors 190, the device 102, the system 100 of FIG. 1A, the TX manager 288, the system 200 of FIG. 2, the system 300 of FIG. 3, the one or more processors 490, the integrated circuit 402 of FIG. 4, the processor 1806, the processor 1810, the antenna 1852, the transceiver 1850, the modem 1870, the device 1800, one or more other circuits or components configured to initiate transmission of first encoder output data, or any combination thereof.

The apparatus also includes means for using a vision encoder to process a second image frame of the sequence of image frames to generate second encoder output data. For example, the means for using a vision encoder can correspond to the vision encoder 180, the one or more processors 190, the device 102, the system 100 of FIG. 1A, the system 200 of FIG. 2, the system 300 of FIG. 3, the one or more processors 490, the integrated circuit 402 of FIG. 4, the processor 1806, the processor 1810, the device 1800, one or more other circuits or components configured to use a vision encoder, or any combination thereof.

The apparatus also includes means for determining, based on a comparison of the first encoder output data and the second encoder output data, whether to initiate transmission of the second encoder output data for image-based cognitive analysis. For example, the means for determining can correspond to the one or more processors 190, the device 102, the system 100 of FIG. 1A, the TX manager 288, the system 200 of FIG. 2, the system 300 of FIG. 3, the one or more processors 490, the integrated circuit 402 of FIG. 4, the processor 1806, the processor 1810, the device 1800, one or more other circuits or components configured to determine whether to initiate transmission of second encoder output data, or any combination thereof.

Also in conjunction with the described implementations, an apparatus includes means for receiving, from a device, first encoder output data for image-based cognitive analysis, the first encoder output data representing a first image frame of a sequence of image frames. For example, the means for receiving can correspond to the system 200 of FIG. 2, the storage manager 388, the system 300 of FIG. 3, the one or more processors 490, the integrated circuit 402 of FIG. 4, the processor 1806, the processor 1810, the antenna 1852, the transceiver 1850, the modem 1870, the device 1800, one or more other circuits or components configured to receive first encoder output data, or any combination thereof.

The apparatus also includes means for adding the first encoder output data to a memory. For example, the means for adding can correspond to the system 200 of FIG. 2, the storage manager 388, the system 300 of FIG. 3, the one or more processors 490, the integrated circuit 402 of FIG. 4, the processor 1806, the processor 1810, the antenna 1852, the transceiver 1850, the modem 1870, the device 1800, one or more other circuits or components configured to add first encoder output data to a memory, or any combination thereof.

The apparatus also includes means for receiving, from the device, second encoder output data for image-based cognitive analysis, the second encoder output data representing a second image frame of the sequence of image frames. For example, the means for receiving can correspond to the system 200 of FIG. 2, the storage manager 388, the system 300 of FIG. 3, the one or more processors 490, the integrated circuit 402 of FIG. 4, the processor 1806, the processor 1810, the antenna 1852, the transceiver 1850, the modem 1870, the device 1800, one or more other circuits or components configured to receive second encoder output data, or any combination thereof.

The apparatus also includes means for determining, based on a comparison of the first encoder output data and the second encoder output data, whether to store the second encoder output data for image-based cognitive analysis. For example, the means for determining can correspond to the system 200 of FIG. 2, the storage manager 388, the system 300 of FIG. 3, the one or more processors 490, the integrated circuit 402 of FIG. 4, the processor 1806, the processor 1810, the antenna 1852, the transceiver 1850, the modem 1870, the device 1800, one or more other circuits or components configured to determine whether to store second encoder output data, or any combination thereof.

In some implementations, a non-transitory computer-readable medium (e.g., a computer-readable storage device, such as the memory 1886) includes instructions (e.g., the instructions 1856) that, when executed by one or more processors (e.g., the one or more processors 1810 or the processor 1806), cause the one or more processors to add, to a memory (e.g., the memory 132), first encoder output data (e.g., the encoder output data 128A) for image-based cognitive analysis, the first encoder output data representing a first image frame (e.g., the image frame 112A) of a sequence of image frames (e.g., the image frames 112). The instructions further cause the one or more processors to use a vision encoder (e.g., the vision encoder 180) to process a second image frame (e.g., the image frame 112B) of the sequence of image frames to generate second encoder output data (e.g., the encoder output data 128B). The instructions further cause the one or more processors to, based on a comparison of the first image frame and the second image frame, determine whether to store the second encoder output data for image-based cognitive analysis.

In some implementations, a non-transitory computer-readable medium (e.g., a computer-readable storage device, such as the memory 1886) includes instructions (e.g., the instructions 1856) that, when executed by one or more processors (e.g., the one or more processors 1810 or the processor 1806), cause the one or more processors to add, to a memory (e.g., the memory 132), first encoder output data (e.g., the encoder output data 128A) for image-based cognitive analysis, the first encoder output data representing a first image frame (e.g., the image frame 112A) of a sequence of image frames (e.g., the image frames 112). The instructions further cause the one or more processors to use a vision encoder (e.g., the vision encoder 180) to process a second image frame (e.g., the image frame 112B) of the sequence of image frames to generate second encoder output data (e.g., the encoder output data 128B). The instructions further cause the one or more processors to, based on a comparison of the first encoder output data and the second encoder output data, determine whether to store the second encoder output data for image-based cognitive analysis.

In some implementations, a non-transitory computer-readable medium (e.g., a computer-readable storage device, such as the memory 1886) includes instructions (e.g., the instructions 1856) that, when executed by one or more processors (e.g., the one or more processors 1810 or the processor 1806), cause the one or more processors to initiate transmission of first encoder output data (e.g., the encoder output data 128A) for image-based cognitive analysis, the first encoder output data representing a first image frame (e.g., the image frame 112A) of a sequence of image frames (e.g., the image frames 112). The instructions further cause the one or more processors to use a vision encoder (e.g., the vision encoder 180) to process a second image frame (e.g., the image frame 112B) of the sequence of image frames to generate second encoder output data (e.g., the encoder output data 128B). The instructions further cause the one or more processors to, based on a comparison of the first image frame and the second image frame, determine whether to initiate transmission of the second encoder output data for the image-based cognitive analysis.

In some implementations, a non-transitory computer-readable medium (e.g., a computer-readable storage device, such as the memory 1886) includes instructions (e.g., the instructions 1856) that, when executed by one or more processors (e.g., the one or more processors 1810 or the processor 1806), cause the one or more processors to initiate transmission of first encoder output data (e.g., the encoder output data 128A) for image-based cognitive analysis, the first encoder output data representing a first image frame (e.g., the image frame 112A) of a sequence of image frames (e.g., the image frames 112). The instructions further cause the one or more processors to use a vision encoder (e.g., the vision encoder 180) to process a second image frame (e.g., the image frame 112B) of the sequence of image frames to generate second encoder output data (e.g., the encoder output data 128B). The instructions further cause the one or more processors to, based on a comparison of the first encoder output data and the second encoder output data, determine whether to initiate transmission of the second encoder output data for image-based cognitive analysis.

In some implementations, a non-transitory computer-readable medium (e.g., a computer-readable storage device, such as the memory 1886) includes instructions (e.g., the instructions 1856) that, when executed by one or more processors (e.g., the one or more processors 1810 or the processor 1806), cause the one or more processors to receive, from a device (e.g., the device 102), first encoder output data (e.g., the encoder output data 128A) for image-based cognitive analysis, the first encoder output data representing a first image frame (e.g., the image frame 112A) of a sequence of image frames (e.g., the image frames 112). The instructions further cause the one or more processors to add the first encoder output data to a memory (e.g., the memory 332). The instructions further cause the one or more processors to receive, from the device, second encoder output data (e.g., the encoder output data 128B) for image-based cognitive analysis, the second encoder output data representing a second image frame (e.g., the image frame 112B) of the sequence of image frames. The instructions further cause the one or more processors to, based on a comparison of the first encoder output data and the second encoder output data, determine whether to store the second encoder output data for image-based cognitive analysis.

Particular aspects of the disclosure are described below in sets of interrelated Examples:

According to Example 1, a device includes a memory configured to store sets of encoder output data; and one or more processors coupled to the memory and configured to add, to the memory, first encoder output data for image-based cognitive analysis, the first encoder output data representing a first image frame of a sequence of image frames; use a vision encoder to process a second image frame of the sequence of image frames to generate second encoder output data; and based on a comparison of the first image frame and the second image frame, determine whether to store the second encoder output data for image-based cognitive analysis.

Example 2 includes the device of Example 1, wherein the one or more processors are configured to, based on determining that a difference between the first image frame and the second image frame fails to satisfy a storage threshold, discard the second encoder output data.

Example 3 includes the device of Example 1 or Example 2, wherein the one or more processors are configured to, based on determining that a difference between the first image frame and the second image frame satisfies a storage threshold, add the second encoder output data to the memory.

Example 4 includes the device of any of Examples 1 to 3, wherein the one or more processors are configured to determine, based on an elapsed time since a first time, whether to store the second encoder output data, wherein the first image frame is added to the memory at the first time.

Example 5 includes the device of any of Examples 1 to 4, wherein the one or more processors are configured to determine, based on a count of image frames between the first image frame and the second image frame, whether to store the second encoder output data.

Example 6 includes the device of any of Examples 1 to 5 and further includes a camera coupled to the one or more processors and configured to generate the sequence of image frames.

Example 7 includes the device of any of Examples 1 to 6 and further includes a modem coupled to the one or more processors and configured to receive the sequence of image frames.

Example 8 includes the device of any of Examples 1 to 7 and further includes a modem coupled to the one or more processors and configured to transmit the first encoder output data.

Example 9 includes the device of any of Examples 1 to 8, wherein the memory and the one or more processors are integrated into a mobile device.

Example 10 includes the device of any of Examples 1 to 9, wherein the memory and the one or more processors are integrated into a headset.

According to Example 11, a device includes a memory configured to store sets of encoder output data; and one or more processors configured to add, to the memory, first encoder output data for image-based cognitive analysis, the first encoder output data representing a first image frame of a sequence of image frames; use a vision encoder to process a second image frame of the sequence of image frames to generate second encoder output data; and based on a comparison of the first encoder output data and the second encoder output data, determine whether to store the second encoder output data for image-based cognitive analysis.

Example 12 includes the device of Example 11, wherein the one or more processors are configured to, based on determining that a difference between the first encoder output data and the second encoder output data fails to satisfy a storage threshold, discard the second encoder output data.

Example 13 includes the device of Example 11 or Example 12, wherein the one or more processors are configured to, based on determining that a difference between the first encoder output data and the second encoder output data satisfies a storage threshold, add the second encoder output data to the memory.

Example 14 includes the device of any of Examples 11 to 13, wherein the one or more processors are configured to determine, based on an elapsed time since a first time, whether to store the second encoder output data, wherein the first encoder output data is added to the memory at the first time.

Example 15 includes the device of any of Examples 11 to 14, wherein the one or more processors are configured to determine, based on a count of image frames between the first image frame and the second image frame, whether to store the second encoder output data.

Example 16 includes the device of any of Examples 11 to 15 and further includes a camera coupled to the one or more processors and configured to generate the sequence of image frames.

Example 17 includes the device of any of Examples 11 to 16 and further includes a modem coupled to the one or more processors and configured to receive the sequence of image frames.

Example 18 includes the device of any of Examples 11 to 17 and further includes a modem coupled to the one or more processors and configured to transmit the first encoder output data.

Example 19 includes the device of any of Examples 11 to 18, wherein the memory and the one or more processors are integrated into a mobile device.

Example 20 includes the device of any of Examples 11 to 19, wherein the memory and the one or more processors are integrated into a headset.

According to Example 21, a device includes a memory configured to store sets of encoder output data; and one or more processors coupled to the memory and configured to initiate transmission of first encoder output data for image-based cognitive analysis, the first encoder output data representing a first image frame of a sequence of image frames; use a vision encoder to process a second image frame of the sequence of image frames to generate second encoder output data; and based on a comparison of the first image frame and the second image frame, determine whether to initiate transmission of the second encoder output data for the image-based cognitive analysis.

Example 22 includes the device of Example 21, wherein the one or more processors are configured to, based on determining that a difference between the first image frame and the second image frame fails to satisfy a transmission threshold, discard the second encoder output data.

Example 23 includes the device of Example 21 or Example 22, wherein the one or more processors are configured to, based on determining that a difference between the first image frame and the second image frame satisfies a transmission threshold, initiate transmission of the second encoder output data.

Example 24 includes the device of any of Examples 21 to 23, wherein the one or more processors are configured to determine, based on an elapsed time since a first time, whether to initiate transmission of the second encoder output data, wherein transmission of the first image frame is initiated at the first time.

Example 25 includes the device of any of Examples 21 to 24, wherein the one or more processors are configured to determine, based on a count of image frames between the first image frame and the second image frame, whether to initiate transmission of the second encoder output data.

Example 26 includes the device of any of Examples 21 to 25 and further includes a camera coupled to the one or more processors and configured to generate the sequence of image frames.

Example 27 includes the device of any of Examples 21 to 26 and further includes a modem coupled to the one or more processors and configured to receive the sequence of image frames.

Example 28 includes the device of any of Examples 21 to 27 and further includes a modem coupled to the one or more processors and configured to transmit the first encoder output data.

Example 29 includes the device of any of Examples 21 to 28, wherein the memory and the one or more processors are integrated into a mobile device.

Example 30 includes the device of any of Examples 21 to 29, wherein the memory and the one or more processors are integrated into a headset.

According to Example 31, a device includes a memory configured to store sets of encoder output data; and one or more processors coupled to the memory and configured to initiate transmission of first encoder output data for image-based cognitive analysis, the first encoder output data representing a first image frame of a sequence of image frames; use a vision encoder to process a second image frame of the sequence of image frames to generate second encoder output data; and based on a comparison of the first encoder output data and the second encoder output data, determine whether to initiate transmission of the second encoder output data for image-based cognitive analysis.

Example 32 includes the device of Example 31, wherein the one or more processors are configured to, based on determining that a difference between the first encoder output data and the second encoder output data fails to satisfy a transmission threshold, discard the second encoder output data.

Example 33 includes the device of Example 31 or Example 32, wherein the one or more processors are configured to, based on determining that a difference between the first encoder output data and the second encoder output data satisfies a transmission threshold, initiate transmission of the second encoder output data.

Example 34 includes the device of any of Examples 31 to 33, wherein the one or more processors are configured to determine, based on an elapsed time since a first time, whether to initiate transmission of the second encoder output data, wherein transmission of the first encoder output data is initiated at the first time.

Example 35 includes the device of any of Examples 31 to 34, wherein the one or more processors are configured to determine, based on a count of image frames between the first image frame and the second image frame, whether to initiate transmission of the second encoder output data.

Example 36 includes the device of any of Examples 31 to 35 and further includes a camera coupled to the one or more processors and configured to generate the sequence of image frames.

Example 37 includes the device of any of Examples 31 to 36 and further includes a modem coupled to the one or more processors and configured to receive the sequence of image frames.

Example 38 includes the device of any of Examples 31 to 37 and further includes a modem coupled to the one or more processors and configured to transmit the first encoder output data.

Example 39 includes the device of any of Examples 31 to 38, wherein the memory and the one or more processors are integrated into a mobile device.

Example 40 includes the device of any of Examples 31 to 39, wherein the memory and the one or more processors are integrated into a headset.

According to Example 41, a device includes a memory configured to store sets of encoder output data; and one or more processors coupled to the memory and configured to receive, from a second device, first encoder output data for image-based cognitive analysis, the first encoder output data representing a first image frame of a sequence of image frames; add the first encoder output data to the memory; receive, from the second device, second encoder output data for image-based cognitive analysis, the second encoder output data representing a second image frame of the sequence of image frames; and based on a comparison of the first encoder output data and the second encoder output data, determine whether to store the second encoder output data for image-based cognitive analysis.

Example 42 includes the device of Example 41, wherein the one or more processors are configured to, based on determining that a difference between the first encoder output data and the second encoder output data fails to satisfy a storage threshold, discard the second encoder output data.

Example 43 includes the device of Example 41 or Example 42, wherein the one or more processors are configured to, based on determining that a difference between the first encoder output data and the second encoder output data satisfies a storage threshold, add the second encoder output data to the memory.

Example 44 includes the device of any of Examples 41 to 43, wherein the one or more processors are configured to determine, based on an elapsed time since a first time, whether to store the second encoder output data, wherein the first encoder output data is added to the memory at the first time.

Example 45 includes the device of any of Examples 41 to 44, wherein the one or more processors are configured to determine, based on a count of image frames between the first image frame and the second image frame, whether to store the second encoder output data.

Example 46 includes the device of any of Examples 41 to 45 and further includes a modem coupled to the one or more processors and configured to receive the first encoder output data.

Example 47 includes the device of any of Examples 41 to 46, wherein the memory and the one or more processors are integrated into a mobile device.

Example 48 includes the device of any of Examples 41 to 47, wherein the memory and the one or more processors are integrated into a headset.

According to Example 49, a method includes adding, to a memory, first encoder output data for image-based cognitive analysis, the first encoder output data representing a first image frame of a sequence of image frames; using a vision encoder to process a second image frame of the sequence of image frames to generate second encoder output data; and based on a comparison of the first image frame and the second image frame, determining whether to store the second encoder output data for image-based cognitive analysis.

Example 50 includes the method of Example 49, further comprising, based on determining that a difference between the first image frame and the second image frame fails to satisfy a storage threshold, discarding the second encoder output data.

Example 51 includes the method of Example 49 or Example 50, further comprising, based on determining that a difference between the first image frame and the second image frame satisfies a storage threshold, adding the second encoder output data to the memory.

Example 52 includes the method of any of Examples 49 to 51 and further includes determining, based on an elapsed time since a first time, whether to store the second encoder output data, wherein the first image frame is added to the memory at the first time.

Example 53 includes the method of any of Examples 49 to 52 and further includes determining, based on a count of image frames between the first image frame and the second image frame, whether to store the second encoder output data.

Example 54 includes the method of any of Examples 49 to 53 and further includes receiving, from a camera, the sequence of image frames.

Example 55 includes the method of any of Examples 49 to 54 and further includes receiving, using a modem, the sequence of image frames.

Example 56 includes the method of any of Examples 49 to 55 and further includes transmitting, using a modem, the first encoder output data.

Example 57 includes the method of any of Examples 49 to 56, wherein the memory is integrated into a mobile device.

Example 58 includes the method of any of Examples 49 to 57, wherein the memory is integrated into a headset.

According to Example 59, a method includes adding, to a memory, first encoder output data for image-based cognitive analysis, the first encoder output data representing a first image frame of a sequence of image frames; using a vision encoder to process a second image frame of the sequence of image frames to generate second encoder output data; and based on a comparison of the first encoder output data and the second encoder output data, determining whether to store the second encoder output data for image-based cognitive analysis.

Example 60 includes the method of Example 59, further comprising, based on determining that a difference between the first encoder output data and the second encoder output data fails to satisfy a storage threshold, discarding the second encoder output data.

Example 61 includes the method of Example 59 or Example 60, further comprising, based on determining that a difference between the first encoder output data and the second encoder output data satisfies a storage threshold, adding the second encoder output data to the memory.

Example 62 includes the method of any of Examples 59 to 61 and further includes determining, based on an elapsed time since a first time, whether to store the second encoder output data, wherein the first encoder output data is added to the memory at the first time.

Example 63 includes the method of any of Examples 59 to 62 and further includes determining, based on a count of image frames between the first image frame and the second image frame, whether to store the second encoder output data.

Example 64 includes the method of any of Examples 59 to 63 and further includes receiving, from a camera, the sequence of image frames.

Example 65 includes the method of any of Examples 59 to 64 and further includes receiving, using a modem, the sequence of image frames.

Example 66 includes the method of any of Examples 59 to 65 and further includes transmitting, using a modem, the first encoder output data.

Example 67 includes the method of any of Examples 59 to 66, wherein the memory is integrated into a mobile device.

Example 68 includes the method of any of Examples 59 to 67, wherein the memory is integrated into a headset.

According to Example 69, a method includes initiating transmission of first encoder output data for image-based cognitive analysis, the first encoder output data representing a first image frame of a sequence of image frames; using a vision encoder to process a second image frame of the sequence of image frames to generate second encoder output data; and based on a comparison of the first image frame and the second image frame, determining whether to initiate transmission of the second encoder output data for the image-based cognitive analysis.

Example 70 includes the method of Example 69, further comprising, based on determining that a difference between the first image frame and the second image frame fails to satisfy a transmission threshold, discarding the second encoder output data.

Example 71 includes the method of Example 69 or Example 70, further comprising, based on determining that a difference between the first image frame and the second image frame satisfies a transmission threshold, initiating transmission of the second encoder output data.

Example 72 includes the method of any of Examples 69 to 71 and further includes determining, based on an elapsed time since a first time, whether to initiate transmission of the second encoder output data, wherein transmission of the first image frame is initiated at the first time.

Example 73 includes the method of any of Examples 69 to 72 and further includes determining, based on a count of image frames between the first image frame and the second image frame, whether to initiate transmission of the second encoder output data.

Example 74 includes the method of any of Examples 69 to 73 and further includes receiving, from a camera, the sequence of image frames.

Example 75 includes the method of any of Examples 69 to 74 and further includes receiving, using a modem, the sequence of image frames.

Example 76 includes the method of any of Examples 69 to 75 and further includes transmitting, using a modem, the first encoder output data.

Example 77 includes the method of any of Examples 69 to 76, wherein the vision encoder is integrated into a mobile device.

Example 78 includes the method of any of Examples 69 to 77, wherein the vision encoder is integrated into a headset.

According to Example 79, a method includes initiating transmission of first encoder output data for image-based cognitive analysis, the first encoder output data representing a first image frame of a sequence of image frames; using a vision encoder to process a second image frame of the sequence of image frames to generate second encoder output data; and based on a comparison of the first encoder output data and the second encoder output data, determining whether to initiate transmission of the second encoder output data for image-based cognitive analysis.

Example 80 includes the method of Example 79, further comprising, based on determining that a difference between the first encoder output data and the second encoder output data fails to satisfy a transmission threshold, discarding the second encoder output data.

Example 81 includes the method of Example 79 or Example 80, further comprising, based on determining that a difference between the first encoder output data and the second encoder output data satisfies a transmission threshold, initiating transmission of the second encoder output data.

Example 82 includes the method of any of Examples 79 to 81 and further includes determining, based on an elapsed time since a first time, whether to initiate transmission of the second encoder output data, wherein transmission of the first encoder output data is initiated at the first time.

Example 83 includes the method of any of Examples 79 to 82 and further includes determining, based on a count of image frames between the first image frame and the second image frame, whether to initiate transmission of the second encoder output data.

Example 84 includes the method of any of Examples 79 to 83 and further includes receiving, from a camera, the sequence of image frames.

Example 85 includes the method of any of Examples 79 to 84 and further includes receiving, using a modem, the sequence of image frames.

Example 86 includes the method of any of Examples 79 to 85 and further includes transmitting, using a modem, the first encoder output data.

Example 87 includes the method of any of Examples 79 to 86, wherein the vision encoder is integrated into a mobile device.

Example 88 includes the method of any of Examples 79 to 87, wherein the vision encoder is integrated into a headset.

According to Example 89, a method includes receiving, at a first device from a second device, first encoder output data for image-based cognitive analysis, the first encoder output data representing a first image frame of a sequence of image frames; adding the first encoder output data to a memory; receiving, at a first device from the second device, second encoder output data for image-based cognitive analysis, the second encoder output data representing a second image frame of the sequence of image frames; and based on a comparison of the first encoder output data and the second encoder output data, determining whether to store the second encoder output data for image-based cognitive analysis.

Example 90 includes the method of Example 89, further comprising, based on determining that a difference between the first encoder output data and the second encoder output data fails to satisfy a storage threshold, discarding the second encoder output data.

Example 91 includes the method of Example 89 or Example 90, further comprising, based on determining that a difference between the first encoder output data and the second encoder output data satisfies a storage threshold, adding the second encoder output data to the memory.

Example 92 includes the method of any of Examples 89 to 91 and further includes determining, based on an elapsed time since a first time, whether to store the second encoder output data, wherein the first encoder output data is added to the memory at the first time.

Example 93 includes the method of any of Examples 89 to 92 and further includes determining, based on a count of image frames between the first image frame and the second image frame, whether to store the second encoder output data.

Example 94 includes the method of any of Examples 89 to 93 and further includes receiving, using a modem, the first encoder output data.

Example 95 includes the method of any of Examples 89 to 94, wherein the memory is integrated into a mobile device.

Example 96 includes the method of any of Examples 89 to 95, wherein the memory is integrated into a headset.

According to Example 97, a non-transitory computer-readable medium stores instructions that, when executed by one or more processors, cause the one or more processors to add, to a memory, first encoder output data for image-based cognitive analysis, the first encoder output data representing a first image frame of a sequence of image frames; use a vision encoder to process a second image frame of the sequence of image frames to generate second encoder output data; and based on a comparison of the first image frame and the second image frame, determine whether to store the second encoder output data for image-based cognitive analysis.

Example 98 includes the non-transitory computer-readable medium of Example 97, wherein the instructions, when executed by one or more processors, cause the one or more processors to, based on determining that a difference between the first image frame and the second image frame fails to satisfy a storage threshold, discard the second encoder output data.

Example 99 includes the non-transitory computer-readable medium of Example 97 or Example 98, wherein the instructions, when executed by one or more processors, cause the one or more processors to, based on determining that a difference between the first image frame and the second image frame satisfies a storage threshold, add the second encoder output data to the memory.

Example 100 includes the non-transitory computer-readable medium of any of Examples 97 to 99, wherein the instructions, when executed by one or more processors, cause the one or more processors to determine, based on an elapsed time since a first time, whether to store the second encoder output data, wherein the first image frame is added to the memory at the first time.

Example 101 includes the non-transitory computer-readable medium of any of Examples 97 to 100, wherein the instructions, when executed by one or more processors, cause the one or more processors to determine, based on a count of image frames between the first image frame and the second image frame, whether to store the second encoder output data.

Example 102 includes the non-transitory computer-readable medium of any of Examples 97 to 101, wherein the instructions, when executed by one or more processors, cause the one or more processors to receive, from a camera, the sequence of image frames.

Example 103 includes the non-transitory computer-readable medium of any of Examples 97 to 102, wherein the instructions, when executed by one or more processors, cause the one or more processors to receive, using a modem, the sequence of image frames.

Example 104 includes the non-transitory computer-readable medium of any of Examples 97 to 103, wherein the instructions, when executed by one or more processors, cause the one or more processors to transmit, using a modem, the first encoder output data.

Example 105 includes the non-transitory computer-readable medium of any of Examples 97 to 104, wherein the memory is integrated into a mobile device.

Example 106 includes the non-transitory computer-readable medium of any of Examples 97 to 105, wherein the memory is integrated into a headset.

According to Example 107, a non-transitory computer-readable medium stores instructions that, when executed by one or more processors, cause the one or more processors to add, to a memory, first encoder output data for image-based cognitive analysis, the first encoder output data representing a first image frame of a sequence of image frames; use a vision encoder to process a second image frame of the sequence of image frames to generate second encoder output data; and based on a comparison of the first encoder output data and the second encoder output data, determine whether to store the second encoder output data for image-based cognitive analysis.

Example 108 includes the non-transitory computer-readable medium of Example 107, wherein the instructions, when executed by one or more processors, cause the one or more processors to, based on determining that a difference between the first encoder output data and the second encoder output data fails to satisfy a storage threshold, discard the second encoder output data.

Example 109 includes the non-transitory computer-readable medium of Example 107 or Example 108, wherein the instructions, when executed by one or more processors, cause the one or more processors to, based on determining that a difference between the first encoder output data and the second encoder output data satisfies a storage threshold, add the second encoder output data to the memory.

Example 110 includes the non-transitory computer-readable medium of any of Examples 107 to 109, wherein the instructions, when executed by one or more processors, cause the one or more processors to determine, based on an elapsed time since a first time, whether to store the second encoder output data, wherein the first encoder output data is added to the memory at the first time.

Example 111 includes the non-transitory computer-readable medium of any of Examples 107 to 110, wherein the instructions, when executed by one or more processors, cause the one or more processors to determine, based on a count of image frames between the first image frame and the second image frame, whether to store the second encoder output data.

Example 112 includes the non-transitory computer-readable medium of any of Examples 107 to 111, wherein the instructions, when executed by one or more processors, cause the one or more processors to receive, from a camera, the sequence of image frames.

Example 113 includes the non-transitory computer-readable medium of any of Examples 107 to 112, wherein the instructions, when executed by one or more processors, cause the one or more processors to receive, using a modem, the sequence of image frames.

Example 114 includes the non-transitory computer-readable medium of any of Examples 107 to 113, wherein the instructions, when executed by one or more processors, cause the one or more processors to transmit, using a modem, the first encoder output data.

Example 115 includes the non-transitory computer-readable medium of any of Examples 107 to 114, wherein the memory is integrated into a mobile device.

Example 116 includes the non-transitory computer-readable medium of any of Examples 107 to 115, wherein the memory is integrated into a headset.

According to Example 117, a non-transitory computer-readable medium stores instructions that, when executed by one or more processors, cause the one or more processors to initiate transmission of first encoder output data for image-based cognitive analysis, the first encoder output data representing a first image frame of a sequence of image frames; use a vision encoder to process a second image frame of the sequence of image frames to generate second encoder output data; and based on a comparison of the first image frame and the second image frame, determine whether to initiate transmission of the second encoder output data for the image-based cognitive analysis.

Example 118 includes the non-transitory computer-readable medium of Example 117, wherein the instructions, when executed by one or more processors, cause the one or more processors to, based on determining that a difference between the first image frame and the second image frame fails to satisfy a transmission threshold, discard the second encoder output data.

Example 119 includes the non-transitory computer-readable medium of Example 117 or Example 118, wherein the instructions, when executed by one or more processors, cause the one or more processors to, based on determining that a difference between the first image frame and the second image frame satisfies a transmission threshold, initiate transmission of the second encoder output data.

Example 120 includes the non-transitory computer-readable medium of any of Examples 117 to 119, wherein the instructions, when executed by one or more processors, cause the one or more processors to determine, based on an elapsed time since a first time, whether to initiate transmission of the second encoder output data, wherein transmission of the first image frame is initiated at the first time.

Example 121 includes the non-transitory computer-readable medium of any of Examples 117 to 120, wherein the instructions, when executed by one or more processors, cause the one or more processors to determine, based on a count of image frames between the first image frame and the second image frame, whether to initiate transmission of the second encoder output data.

Example 122 includes the non-transitory computer-readable medium of any of Examples 117 to 121, wherein the instructions, when executed by one or more processors, cause the one or more processors to receive, from a camera, the sequence of image frames.

Example 123 includes the non-transitory computer-readable medium of any of Examples 117 to 122, wherein the instructions, when executed by one or more processors, cause the one or more processors to receive, using a modem, the sequence of image frames.

Example 124 includes the non-transitory computer-readable medium of any of Examples 117 to 123, wherein the instructions, when executed by one or more processors, cause the one or more processors to transmit, using a modem, the first encoder output data.

Example 125 includes the non-transitory computer-readable medium of any of Examples 117 to 124, wherein the vision encoder is integrated into a mobile device.

Example 126 includes the non-transitory computer-readable medium of any of Examples 117 to 125, wherein the vision encoder is integrated into a headset.

According to Example 127, a non-transitory computer-readable medium stores instructions that, when executed by one or more processors, cause the one or more processors to initiate transmission of first encoder output data for image-based cognitive analysis, the first encoder output data representing a first image frame of a sequence of image frames; use a vision encoder to process a second image frame of the sequence of image frames to generate second encoder output data; and based on a comparison of the first encoder output data and the second encoder output data, determine whether to initiate transmission of the second encoder output data for image-based cognitive analysis.

Example 128 includes the non-transitory computer-readable medium of Example 127, wherein the instructions, when executed by one or more processors, cause the one or more processors to, based on determining that a difference between the first encoder output data and the second encoder output data fails to satisfy a transmission threshold, discard the second encoder output data.

Example 129 includes the non-transitory computer-readable medium of Example 127 or Example 128, wherein the instructions, when executed by one or more processors, cause the one or more processors to, based on determining that a difference between the first encoder output data and the second encoder output data satisfies a transmission threshold, initiate transmission of the second encoder output data.

Example 130 includes the non-transitory computer-readable medium of any of Examples 127 to 129, wherein the instructions, when executed by one or more processors, cause the one or more processors to determine, based on an elapsed time since a first time, whether to initiate transmission of the second encoder output data, wherein transmission of the first encoder output data is initiated at the first time.

Example 131 includes the non-transitory computer-readable medium of any of Examples 127 to 130, wherein the instructions, when executed by one or more processors, cause the one or more processors to determine, based on a count of image frames between the first image frame and the second image frame, whether to initiate transmission of the second encoder output data.

Example 132 includes the non-transitory computer-readable medium of any of Examples 127 to 131, wherein the instructions, when executed by one or more processors, cause the one or more processors to receive, from a camera, the sequence of image frames.

Example 133 includes the non-transitory computer-readable medium of any of Examples 127 to 132, wherein the instructions, when executed by one or more processors, cause the one or more processors to receive, using a modem, the sequence of image frames.

Example 134 includes the non-transitory computer-readable medium of any of Examples 127 to 133, wherein the instructions, when executed by one or more processors, cause the one or more processors to transmit, using a modem, the first encoder output data.

Example 135 includes the non-transitory computer-readable medium of any of Examples 127 to 134, wherein the vision encoder is integrated into a mobile device.

Example 136 includes the non-transitory computer-readable medium of any of Examples 127 to 135, wherein the vision encoder is integrated into a headset.

According to Example 137, a non-transitory computer-readable medium stores instructions that, when executed by one or more processors, cause the one or more processors to receive, from a device, first encoder output data for image-based cognitive analysis, the first encoder output data representing a first image frame of a sequence of image frames; add the first encoder output data to a memory; receive, from the device, second encoder output data for image-based cognitive analysis, the second encoder output data representing a second image frame of the sequence of image frames; and based on a comparison of the first encoder output data and the second encoder output data, determine whether to store the second encoder output data for image-based cognitive analysis.

Example 138 includes the non-transitory computer-readable medium of Example 137, wherein the instructions, when executed by one or more processors, cause the one or more processors to, based on determining that a difference between the first encoder output data and the second encoder output data fails to satisfy a storage threshold, discard the second encoder output data.

Example 139 includes the non-transitory computer-readable medium of Example 137 or Example 138, wherein the instructions, when executed by one or more processors, cause the one or more processors to, based on determining that a difference between the first encoder output data and the second encoder output data satisfies a storage threshold, add the second encoder output data to the memory.

Example 140 includes the non-transitory computer-readable medium of any of Examples 137 to 139, wherein the instructions, when executed by one or more processors, cause the one or more processors to determine, based on an elapsed time since a first time, whether to store the second encoder output data, wherein the first encoder output data is added to the memory at the first time.

Example 141 includes the non-transitory computer-readable medium of any of Examples 137 to 140, wherein the instructions, when executed by one or more processors, cause the one or more processors to determine, based on a count of image frames between the first image frame and the second image frame, whether to store the second encoder output data.

Example 142 includes the non-transitory computer-readable medium of any of Examples 137 to 141, wherein the instructions, when executed by one or more processors, cause the one or more processors to receive, using a modem, the first encoder output data.

Example 143 includes the non-transitory computer-readable medium of any of Examples 137 to 142, wherein the memory is integrated into a mobile device.

Example 144 includes the non-transitory computer-readable medium of any of Examples 137 to 143, wherein the memory is integrated into a headset.

According to Example 145, an apparatus includes means for adding, to a memory, first encoder output data for image-based cognitive analysis, the first encoder output data representing a first image frame of a sequence of image frames; means for using a vision encoder to process a second image frame of the sequence of image frames to generate second encoder output data; and means for determining, based on a comparison of the first image frame and the second image frame, whether to store the second encoder output data for image-based cognitive analysis.

Example 146 includes the apparatus of Example 145, further comprising means for discarding, based on determining that a difference between the first image frame and the second image frame fails to satisfy a storage threshold, the second encoder output data.

Example 147 includes the apparatus of Example 145 or Example 146, further comprising means for adding, based on determining that a difference between the first image frame and the second image frame satisfies a storage threshold, the second encoder output data to the memory.

Example 148 includes the apparatus of any of Examples 145 to 147 and further includes means for determining, based on an elapsed time since a first time, whether to store the second encoder output data, wherein the first image frame is added to the memory at the first time.

Example 149 includes the apparatus of any of Examples 145 to 148 and further includes means for determining, based on a count of image frames between the first image frame and the second image frame, whether to store the second encoder output data.

Example 150 includes the apparatus of any of Examples 145 to 149 and further includes means for generating the sequence of image frames.

Example 151 includes the apparatus of any of Examples 145 to 150 and further includes means for receiving, using a modem, the sequence of image frames.

Example 152 includes the apparatus of any of Examples 145 to 151 and further includes means for transmitting, using a modem, the first encoder output data.

Example 153 includes the apparatus of any of Examples 145 to 152, wherein the memory is integrated into a mobile device.

Example 154 includes the apparatus of any of Examples 145 to 153, wherein the memory is integrated into a headset.

According to Example 155, an apparatus includes means for adding, to a memory, first encoder output data for image-based cognitive analysis, the first encoder output data representing a first image frame of a sequence of image frames; means for using a vision encoder to process a second image frame of the sequence of image frames to generate second encoder output data; and means for determining, based on a comparison of the first encoder output data and the second encoder output data, whether to store the second encoder output data for image-based cognitive analysis.

Example 156 includes the apparatus of Example 155, further comprising means for discarding, based on determining that a difference between the first encoder output data and the second encoder output data fails to satisfy a storage threshold, the second encoder output data.

Example 157 includes the apparatus of Example 155 or Example 156, further comprising means for adding, based on determining that a difference between the first encoder output data and the second encoder output data satisfies a storage threshold, the second encoder output data to the memory.

Example 158 includes the apparatus of any of Examples 155 to 157 and further includes means for determining, based on an elapsed time since a first time, whether to store the second encoder output data, wherein the first encoder output data is added to the memory at the first time.

Example 159 includes the apparatus of any of Examples 155 to 158 and further includes means for determining, based on a count of image frames between the first image frame and the second image frame, whether to store the second encoder output data.

Example 160 includes the apparatus of any of Examples 155 to 159 and further includes means for generating the sequence of image frames.

Example 161 includes the apparatus of any of Examples 155 to 160 and further includes means for receiving, using a modem, the sequence of image frames.

Example 162 includes the apparatus of any of Examples 155 to 161 and further includes means for transmitting, using a modem, the first encoder output data.

Example 163 includes the apparatus of any of Examples 155 to 162, wherein the memory is integrated into a mobile device.

Example 164 includes the apparatus of any of Examples 155 to 163, wherein the memory is integrated into a headset.

According to Example 165, an apparatus includes means for initiating transmission of first encoder output data for image-based cognitive analysis, the first encoder output data representing a first image frame of a sequence of image frames; means for using a vision encoder to process a second image frame of the sequence of image frames to generate second encoder output data; and means for determining, based on a comparison of the first image frame and the second image frame, whether to initiate transmission of the second encoder output data for the image-based cognitive analysis.

Example 166 includes the apparatus of Example 165, further comprising means for discarding, based on determining that a difference between the first image frame and the second image frame fails to satisfy a transmission threshold, the second encoder output data.

Example 167 includes the apparatus of Example 165 or Example 166, further comprising means for initiating, based on determining that a difference between the first image frame and the second image frame satisfies a transmission threshold, transmission of the second encoder output data.

Example 168 includes the apparatus of any of Examples 165 to 167 and further includes means for determining, based on an elapsed time since a first time, whether to initiate transmission of the second encoder output data, wherein transmission of the first image frame is initiated at the first time.

Example 169 includes the apparatus of any of Examples 165 to 168 and further includes means for determining, based on a count of image frames between the first image frame and the second image frame, whether to initiate transmission of the second encoder output data.

Example 170 includes the apparatus of any of Examples 165 to 169 and further includes means for generating the sequence of image frames.

Example 171 includes the apparatus of any of Examples 165 to 170 and further includes means for receiving, using a modem, the sequence of image frames.

Example 172 includes the apparatus of any of Examples 165 to 171 and further includes means for transmitting, using a modem, the first encoder output data.

Example 173 includes the apparatus of any of Examples 165 to 172, wherein the vision encoder is integrated into a mobile device.

Example 174 includes the apparatus of any of Examples 165 to 173, wherein the vision encoder is integrated into a headset.

According to Example 175, an apparatus includes means for initiating transmission of first encoder output data for image-based cognitive analysis, the first encoder output data representing a first image frame of a sequence of image frames; means for using a vision encoder to process a second image frame of the sequence of image frames to generate second encoder output data; and means for determining, based on a comparison of the first encoder output data and the second encoder output data, whether to initiate transmission of the second encoder output data for image-based cognitive analysis.

Example 176 includes the apparatus of Example 175, further comprising means for discarding, based on determining that a difference between the first encoder output data and the second encoder output data fails to satisfy a transmission threshold, the second encoder output data.

Example 177 includes the apparatus of Example 175 or Example 176, further comprising means for initiating, based on determining that a difference between the first encoder output data and the second encoder output data satisfies a transmission threshold, transmission of the second encoder output data.

Example 178 includes the apparatus of any of Examples 175 to 177 and further includes means for determining, based on an elapsed time since a first time, whether to initiate transmission of the second encoder output data, wherein transmission of the first encoder output data is initiated at the first time.

Example 179 includes the apparatus of any of Examples 175 to 178 and further includes means for determining, based on a count of image frames between the first image frame and the second image frame, whether to initiate transmission of the second encoder output data.

Example 180 includes the apparatus of any of Examples 175 to 179 and further includes means for generating the sequence of image frames.

Example 181 includes the apparatus of any of Examples 175 to 180 and further includes means for receiving, using a modem, the sequence of image frames.

Example 182 includes the apparatus of any of Examples 175 to 181 and further includes means for transmitting, using a modem, the first encoder output data.

Example 183 includes the apparatus of any of Examples 175 to 182, wherein the vision encoder is integrated into a mobile device.

Example 184 includes the apparatus of any of Examples 175 to 183, wherein the vision encoder is integrated into a headset.

According to Example 185, an apparatus includes means for receiving, from a device, first encoder output data for image-based cognitive analysis, the first encoder output data representing a first image frame of a sequence of image frames; means for adding the first encoder output data to a memory; means for receiving, from the device, second encoder output data for image-based cognitive analysis, the second encoder output data representing a second image frame of the sequence of image frames; and means for determining, based on a comparison of the first encoder output data and the second encoder output data, whether to store the second encoder output data for image-based cognitive analysis.

Example 186 includes the apparatus of Example 185, further comprising means for discarding, based on determining that a difference between the first encoder output data and the second encoder output data fails to satisfy a storage threshold, the second encoder output data.

Example 187 includes the apparatus of Example 185 or Example 186, further comprising means for adding, based on determining that a difference between the first encoder output data and the second encoder output data satisfies a storage threshold, the second encoder output data to the memory.

Example 188 includes the apparatus of any of Examples 185 to 187 and further includes means for determining, based on an elapsed time since a first time, whether to store the second encoder output data, wherein the first encoder output data is added to the memory at the first time.

Example 189 includes the apparatus of any of Examples 185 to 188 and further includes means for determining, based on a count of image frames between the first image frame and the second image frame, whether to store the second encoder output data.

Example 190 includes the apparatus of any of Examples 185 to 189 and further includes means for receiving, using a modem, the first encoder output data.

Example 191 includes the apparatus of any of Examples 185 to 190, wherein the memory is integrated into a mobile device.

Example 192 includes the apparatus of any of Examples 185 to 191, wherein the memory is integrated into a headset.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store sets of encoder output data; and
one or more processors coupled to the memory and configured to:
add, to the memory, first encoder output data for image-based cognitive analysis, the first encoder output data representing a first image frame of a sequence of image frames;
use a vision encoder to process a second image frame of the sequence of image frames to generate second encoder output data; and
based on a comparison of the first image frame and the second image frame, determine whether to store the second encoder output data for image-based cognitive analysis.

2. The device of claim 1, wherein the one or more processors are configured to, based on determining that a difference between the first image frame and the second image frame fails to satisfy a storage threshold, discard the second encoder output data.

3. The device of claim 1, wherein the one or more processors are configured to, based on determining that a difference between the first image frame and the second image frame satisfies a storage threshold, add the second encoder output data to the memory.

4. The device of claim 1, wherein the one or more processors are configured to determine, based on an elapsed time since a first time, whether to store the second encoder output data, wherein the first image frame is added to the memory at the first time.

5. The device of claim 1, wherein the one or more processors are configured to determine, based on a count of image frames between the first image frame and the second image frame, whether to store the second encoder output data.

6. The device of claim 1, further comprising a camera coupled to the one or more processors and configured to generate the sequence of image frames.

7. The device of claim 1, further comprising a modem coupled to the one or more processors and configured to receive the sequence of image frames.

8. The device of claim 1, further comprising a modem coupled to the one or more processors and configured to transmit the first encoder output data.

9. The device of claim 1, wherein the memory and the one or more processors are integrated into a mobile device.

10. The device of claim 1, wherein the memory and the one or more processors are integrated into a headset.

11. A device comprising:
a memory configured to store sets of encoder output data; and
one or more processors configured to:
add, to the memory, first encoder output data for image-based cognitive analysis, the first encoder output data representing a first image frame of a sequence of image frames;
use a vision encoder to process a second image frame of the sequence of image frames to generate second encoder output data; and
based on a comparison of the first encoder output data and the second encoder output data, determine whether to store the second encoder output data for image-based cognitive analysis.

12. The device of claim 11, wherein the one or more processors are configured to, based on determining that a difference between the first encoder output data and the second encoder output data fails to satisfy a storage threshold, discard the second encoder output data.

13. The device of claim 11, wherein the one or more processors are configured to, based on determining that a difference between the first encoder output data and the second encoder output data satisfies a storage threshold, add the second encoder output data to the memory.

14. The device of claim 11, wherein the one or more processors are configured to determine, based on an elapsed time since a first time, whether to store the second encoder output data, wherein the first encoder output data is added to the memory at the first time.

15. The device of claim 11, wherein the one or more processors are configured to determine, based on a count of image frames between the first image frame and the second image frame, whether to store the second encoder output data.

16. The device of claim 11, further comprising a camera coupled to the one or more processors and configured to generate the sequence of image frames.

17. The device of claim 11, further comprising a modem coupled to the one or more processors and configured to receive the sequence of image frames.

18. The device of claim 11, further comprising a modem coupled to the one or more processors and configured to transmit the first encoder output data.

19. The device of claim 11, wherein the memory and the one or more processors are integrated into a mobile device.

20. The device of claim 11, wherein the memory and the one or more processors are integrated into a headset.

21. A device comprising:
a memory configured to store sets of encoder output data; and
one or more processors coupled to the memory and configured to:
initiate transmission of first encoder output data for image-based cognitive analysis, the first encoder output data representing a first image frame of a sequence of image frames;
use a vision encoder to process a second image frame of the sequence of image frames to generate second encoder output data; and
based on a comparison of the first image frame and the second image frame, determine whether to initiate transmission of the second encoder output data for the image-based cognitive analysis.

22. The device of claim 21, wherein the one or more processors are configured to, based on determining that a difference between the first image frame and the second image frame fails to satisfy a transmission threshold, discard the second encoder output data.

23. The device of claim 21, wherein the one or more processors are configured to, based on determining that a difference between the first image frame and the second image frame satisfies a transmission threshold, initiate transmission of the second encoder output data.

24. The device of claim 21, wherein the one or more processors are configured to determine, based on an elapsed time since a first time, whether to initiate transmission of the second encoder output data, wherein transmission of the first image frame is initiated at the first time.

25. The device of claim 21, wherein the one or more processors are configured to determine, based on a count of image frames between the first image frame and the second image frame, whether to initiate transmission of the second encoder output data.

26. The device of claim 21, further comprising a camera coupled to the one or more processors and configured to generate the sequence of image frames.

27. The device of claim 21, further comprising a modem coupled to the one or more processors and configured to receive the sequence of image frames.

28. The device of claim 21, further comprising a modem coupled to the one or more processors and configured to transmit the first encoder output data.

29. The device of claim 21, wherein the memory and the one or more processors are integrated into a mobile device.

30. A device comprising:
a memory configured to store sets of encoder output data; and
one or more processors coupled to the memory and configured to:
receive, from a second device, first encoder output data for image-based cognitive analysis, the first encoder output data representing a first image frame of a sequence of image frames;
add the first encoder output data to the memory;
receive, from the second device, second encoder output data for image-based cognitive analysis, the second encoder output data representing a second image frame of the sequence of image frames; and
based on a comparison of the first encoder output data and the second encoder output data, determine whether to store the second encoder output data for image-based cognitive analysis.
